(19) United States
(12) Patent Application Publication
(10) Pub. No.: US 2009/0227736 A1
(43) Pub. Date: Sep. 10, 2009

(54) COMPOSITION FOR FORMING A FILM, INSULATING FILM OBTAINED FROM THE COMPOSITION, AND ELECTRONIC DEVICE

(75) Inventors: Keiji YAMAMOTO, Shizuoka (JP); Haruki Inabe, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/399,571

(22) Filed: Mar. 6, 2009

(30) Foreign Application Priority Data
Mar. 7, 2008 (JP) 2008-058036

(51) Int. Cl. C08L 23/00

(52) U.S. Cl. 525/55

(57) ABSTRACT

A composition for film formation which enables formation of an insulating film having excellent resistance to cracking and low relative dielectric constant and exhibiting stable dielectric constant for a long term even after film formation is provided. The composition for forming a film includes a compound having a cage structure and an aromatic ester compound represented by the following general formula (I):

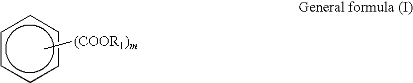

wherein R₁ independently represents an alkyl group, and m represents an integer of 1 to 6.

The entire contents of all documents cited in this specification are incorporated herein by reference.

### BACKGROUND OF THE INVENTION

This invention relates to a composition for forming a film, and more specifically, to a composition for forming an insulating film adapted for use in an electronic device which has improved dielectric constant, mechanical strength, heat resistance, and other properties. This invention also relates to an electronic device having the insulating film prepared from such composition.

In the field of electronic materials, recent quest for high integration, multifunction, and high performance has invited increase in the resistance of the circuit and capacity of the condenser between interconnects and this, in turn, invited increase in the electric power consumption and delay time. Among these, the increase in delay time has been a primary factor for decrease in signal speed of the device and generation of crosstalk. Therefore, reduction of the delay time is required for the speed up of the device, and reduction of parasitic resistance and parasitic capacity is needed. In order to reduce the parasitic capacity, attempts have been made to cover the periphery of the interconnects with a low dielectric interlayer insulating film. The interlayer insulating film is also required to have excellent heat resistance to endure the thin film formation steps in the production of the packaged board or in the post steps such as chip connection and pin attachment steps as well as high chemical resistance sufficient to withstand the wet process. In addition, low resistance Cu interconnects have been recently introduced instead of Al interconnects, and along with this, use of CMP (chemical mechanical polishing) has become commonplace for planarization. Accordingly, the insulating film is required to have the mechanical strength of the level sufficient to withstand the CMP.

Silicon dioxide (SiO₂, k=3.9) has been used for the insulating film that covers the interconnects. Silicon dioxide, however, has been pointed out to have the problems of relatively high dielectric constant and requirement of a large scale installation for vacuum deposition. In view of such situation, attempts have been made to develop an insulating film having a lower dielectric constant, and use of spin coating which enables easy control of the film structure is one such attempt. For example, JP 2003-176352 A discloses a material for use in the production of an insulating film containing a polyamide as a film forming component which has excellent heat resistance and mechanical properties. U.S. Pat. No. 5,965,679 B discloses usefulness of polyphenylene oligomer and polymer in producing the insulating film. JP 2006-233128 A, JP 2006-265513 A, and JP 2007-119706 A disclose insulating films produced by using a compound having a cage structure.

### SUMMARY OF THE INVENTION

In the meanwhile, the insulating film used in semiconductor devices should exhibit stable dielectric constant after the film formation. For example, if the relative dielectric constant gradually increases after the film formation by absorbing ambient moisture, such increase in the relative dielectric constant has adverse influence on the performance of the resulting semiconductor device. The inventors of the present invention made an investigation on the material used for producing an insulating film, and in the investigation, the inventors found that these films are insufficient in long term stability of the dielectric constant after the film formation.

In addition, in cases where a conventional insulating film-forming material is used to form a film, fissures or cracks readily occurred in the resulting film due to a stress generated during solvent drying or heat shrinkage. Cracks that occur in an insulating film used in a semiconductor device may adversely affect the device performance and reduce the yield, and is therefore not preferable.

In view of such problems associated with the conventional materials used for forming the insulating film, an object of the present invention is to provide a composition for film formation which enables formation of an insulating film having excellent resistance to cracking and low relative dielectric constant and exhibiting stable dielectric constant for a long term even after film formation.

The inventors of the present invention conducted an intensive study, and found that the problems as described above can be obviated by the following [1] to [13].

[1] A composition for forming a film comprising a compound having a cage structure and an aromatic ester compound represented by the following general formula (I):

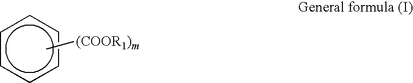

wherein R₁ represents an alkyl group, and m represents an integer of 1 to 6 with the proviso that R₁ may be either the same or different when m represents an integer of 2 or more.
[2] The composition for film formation according to [1] wherein m in the general formula (1) is an integer of 2 to 6.
[3] The composition for film formation according to [1] wherein the aromatic ester compound is one represented by the following general formula (II):

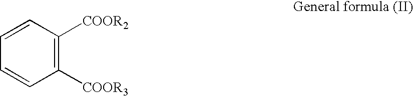

wherein R₂ and R₃ independently represent an alkyl group.
[4] The composition for film formation according to [1] wherein the aromatic ester compound is one represented by the following general formula (III):

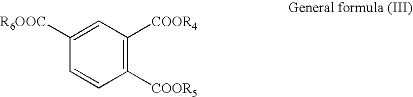

wherein R₄ to R₆ independently represent an alkyl group.
[5] The composition for film formation according to [1] wherein the aromatic ester compound is one represented by the following general formula (IV):

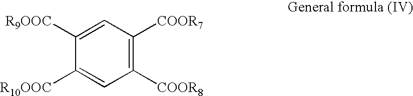

wherein R₇ to R₁₀ independently represent an alkyl group.
[6] The composition for film formation according to [1] wherein the alkyl group is a long chain alkyl group containing at least 6 carbon atoms.
[7] The composition for film formation according to [1] wherein the compound having a cage structure is a polymer of a monomer having a cage structure.
[8] The composition for film formation according to [7] wherein the monomer having a cage structure has a polymerizable carbon-carbon double bond or carbon-carbon triple bond.
[9] The composition for film formation according to [1] wherein the cage structure is a member selected from the group consisting of adamantane, biadamantane, diamantane, triamantane, and tetramantane.
[10] The composition for film formation according to [7] wherein the monomer having a cage structure is a compound represented by any one of the following general formulae (V) to (X):

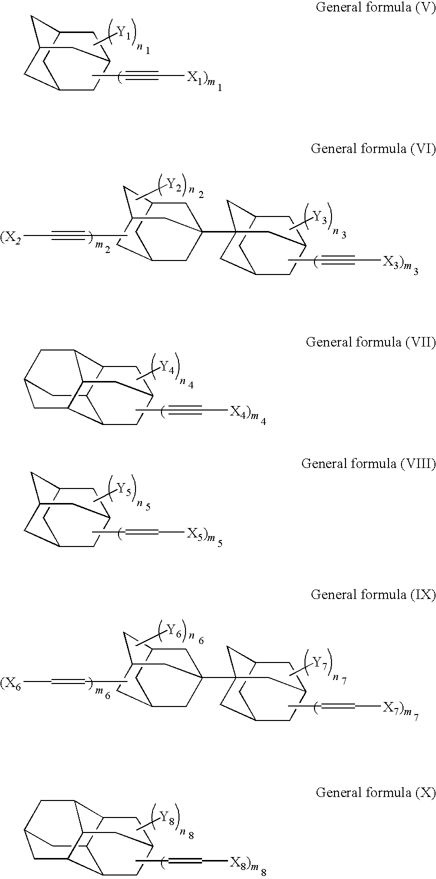

wherein X₁ to X₈ independently represent hydrogen atom, an alkyl group containing 1 to 10 carbon atoms, an alkenyl group containing 2 to 10 carbon atoms, an alkynyl group containing 2 to 10 carbon atoms, an aryl group containing 6 to 20 carbon atoms, a silyl group containing 0 to 20 carbon atoms, an acyl group containing 2 to 10 carbon atoms, an alkoxycarbonyl group containing 2 to 10 carbon atoms, or a carbamoyl group containing 1 to 20 carbon atoms,

Y₁ to Y₈ independently represent a halogen atom, an alkyl group containing 1 to 10 carbon atoms, an aryl group containing 6 to 20 carbon atoms, or a silyl group containing 0 to 20 carbon atoms,

m₁ and m₅ independently represent an integer of 1 to 16, and n₁ and n₅ independently represent an integer of 0 to 15,

m₂, m₃, m₆, and m₇ independently represent an integer of 1 to 15, and n₂, n₃, n₆, and n₇ independently represent an integer of 0 to 14, and

m₄ and m₈ independently represent an integer of 1 to 20, and n₄ and n₈ independently represent an integer of 0 to 19.

[11] The composition for film formation according to [7] wherein the monomer having a cage structure is a compound represented by any one of the following general formulae (Q-1) to (Q-6):

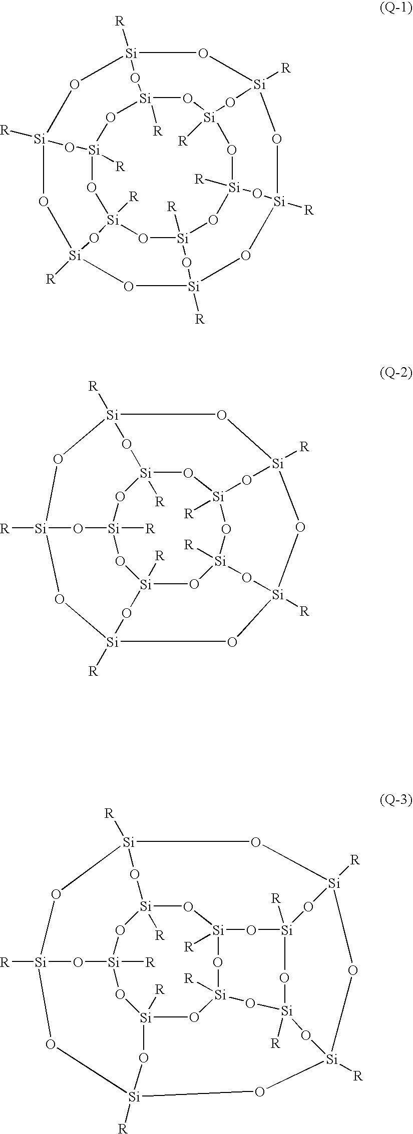

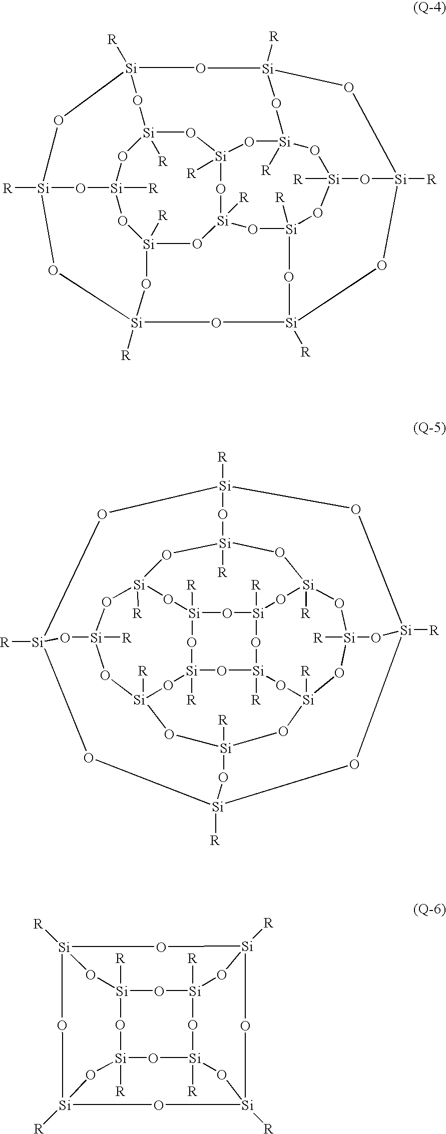

wherein R independently represents a non-hydrolyzable group, and at least 2 of the R are groups containing either vinyl group or ethynyl group.
[12] An insulating film formed by using the composition for film formation of any one of [1] to [11].
[13] An electronic device having the insulating film of [12].

The present invention as summarized above has enabled formation of an insulating film having properties including excellent resistance to cracking, low relative dielectric constant and high heat resistance, which is well adapted for use as an interlayer insulating film in devices such as semiconductor devices. More specifically, the present invention has enabled to form an insulating film which retains its low relative dielectric constant even if stored under high temperature, high humidity conditions after the formation of the film.

### DETAILED DESCRIPTION OF THE INVENTION

Next, the present invention is described in detail by referring to various embodiments.

### [Aromatic Ester Compound]

The composition for film formation of the present invention contains an aromatic ester compound represented by the following general formula (I):

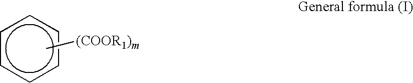

wherein R₁ represents an alkyl group, and m represents an integer of 1 to 6 with the proviso that R₁ may be either the same or different when m represents an integer of 2 or more. By containing such compound, increase in the dielectric constant and loss of other characteristic properties with lapse of time will be suppressed.

R₁ in the general formula (I) represents an alkyl group. The alkyl group may be any of linear, branched, and cyclic alkyl groups, and preferably, the alkyl group is a linear or branched alkyl group. The alkyl group is not limited for its number of carbon atoms in the group, and the preferred are those containing 6 to 20 carbon atoms. Exemplary alkyl groups include methyl group, ethyl group, n-propyl group, isopropyl group, n-butyl group, isobutyl group, 2,3-dimethylbutyl group, s-butyl group, t-butyl group, pentyl group, isopentyl group, neopentyl group, n-hexyl group, 2-ethylhexyl group, isohexyl group, n-heptyl group, isoheptyl group, n-octyl group, isooctyl group, n-nonyl group, isononyl group, n-decyl group, isodecyl group, n-undecyl group, isoundecyl group, n-dodecyl group, isododecyl group, n-tridecyl group, isotridecyl group, n-tetradecyl group, isotetradecyl group, n-pentadecyl group, isopentadecyl group, n-hexadecyl group, isohexadecyl group, n-heptadecyl group, isoheptadecyl group, n-octadecyl group, isooctadecyl group, n-nonyldecyl group, isononyldecyl group, n-eicosanyl group, and isoelcosanyl group.

In the general formula (1), m represents an integer of 1 to 6, preferably 2 to 6, and more preferably 2 to 4.

One preferable embodiments of the compounds represented by the general formula (I) is the one represented by the general formula (II):

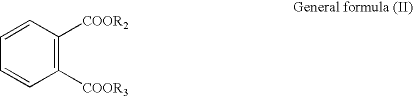

wherein R₂ and R₃ independently represent an alkyl group.

As described above, R₂ and R₃ in the general formula (II) independently represent an alkyl group, which may be any one of linear, branched, and cyclic alkyl group, and preferably, the alkyl group is a linear or branched alkyl group. The alkyl group is not limited for its number of carbon atoms in the group, and the preferred are those containing 6 to 20 carbon atoms. Exemplary alkyl groups include methyl group, ethyl group, n-propyl group, isopropyl group, n-butyl group, isobutyl group, 2,3-dimethylbutyl group, s-butyl group, t-butyl group, pentyl group, isopentyl group, neopentyl group, n-hexyl group, 2-ethylhexyl group, isohexyl group, n-heptyl group, isoheptyl group, n-octyl group, isooctyl group, n-nonyl group, isononyl group, n-decyl group, isodecyl group, n-undecyl group, isoundecyl group, n-dodecyl group, isododecyl group, n-tridecyl group, isotridecyl group, n-tetradecyl group, isotetradecyl group, n-pentadecyl group, isopentadecyl group, n-hexadecyl group, isohexadecyl group, n-heptadecyl group, isoheptadecyl group, n-octadecyl group, isooctadecyl group, n-nonyldecyl group, isononyldecyl group, n-eicosanyl group, and isoeicosanyl group.

One preferable embodiments of the compounds represented by the general formula (I) is the one represented by the general formula (III):

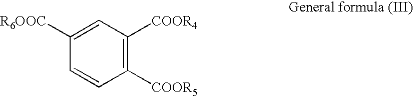

wherein R₄ to R₆ independently represent an alkyl group.

As described above, R₄ to R₆ in the general formula (III) independently represent an alkyl group, which may be any one of linear, branched, and cyclic alkyl group, and preferably, the alkyl group is a linear or branched alkyl group. The alkyl group is not limited for its number of carbon atoms in the group, and the preferred are those containing 6 to 20 carbon atoms. Exemplary alkyl groups include methyl group, ethyl group, n-propyl group, isopropyl group, n-butyl group, isobutyl group, 2,3-dimethylbutyl group, s-butyl group, t-butyl group, pentyl group, isopentyl group, neopentyl group, n-hexyl group, 2-ethylhexyl group, isohexyl group, n-heptyl group, isoheptyl group, n-octyl group, isooctyl group, n-nonyl group, isononyl group, n-decyl group, isodecyl group, n-undecyl group, isoundecyl group, n-dodecyl group, isododecyl group, n-tridecyl group, isotridecyl group, n-tetradecyl group, isotetradecyl group, n-pentadecyl group, isopentadecyl group, n-hexadecyl group, isohexadecyl group, n-heptadecyl group, isoheptadecyl group, n-octadecyl group, isooctadecyl group, n-nonyldecyl group, isononyldecyl group, n-eicosanyl group, and isoeicosanyl group.

One preferable embodiments of the compounds represented by the general formula (I) is the one represented by the general formula (IV):

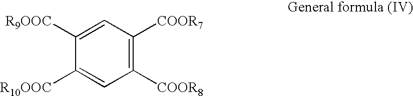

wherein R₇ to R₁₀ independently represent an alkyl group.

As described above, R₇ to R₁₀ in the general formula (IV) independently represent an alkyl group, which may be any one of linear, branched, and cyclic alkyl group, and preferably, the alkyl group is a linear or branched alkyl group. The alkyl group is not limited for its number of carbon atoms in the group, and the preferred are those containing 6 to 20 carbon atoms. Exemplary alkyl groups include methyl group, ethyl group, n-propyl group, isopropyl group, n-butyl group, isobutyl group, 2,3-dimethylbutyl group, s-butyl group, t-butyl group, pentyl group, isopentyl group, neopentyl group, n-hexyl group, 2-ethylhexyl group, isohexyl group, n-heptyl group, isoheptyl group, n-octyl group, isooctyl group, n-nonyl group, isononyl group, n-decyl group, isodecyl group, n-undecyl group, isoundecyl group, n-dodecyl group, isododecyl group, n-tridecyl group, isotridecyl group, n-tetradecyl group, isotetradecyl group, n-pentadecyl group, isopentadecyl group, n-hexadecyl group, isohexadecyl group, n-heptadecyl group, isoheptadecyl group, n-octadecyl group, isooctadecyl group, n-nonyldecyl group, isononyldecyl group, n-eicosanyl group, and isoeicosanyl group.

Preferably, the aromatic ester compound has a long chain alkyl group containing at least 6 carbon atoms, more preferably 6 to 18 carbon atoms, and still more preferably 8 to 16 carbon atoms in view of the long term stability of the relative dielectric constant. Exemplary such alkyl groups include n-hexyl group, 2-ethylhexyl group, isohexyl group, n-heptyl group, isoheptyl group, n-octyl group, isooctyl group, n-nonyl group, isononyl group, n-decyl group, isodecyl group, n-undecyl group, isoundecyl group, n-dodecyl group, isododecyl group, n-tridecyl group, isotridecyl group, n-tetradecyl group, isotetradecyl group, n-pentadecyl group, isopentadecyl group, n-hexadecyl group, isohexadecyl group, n-heptadecyl group, isoheptadecyl group, n-octadecyl group, isooctadecyl group, n-nonyldecyl group, isononyldecyl group, n-eicosanyl group, and isoeicosanyl group. Among these, the preferred are 2-ethylhexyl group, isohexyl group, n-heptyl group, isoheptyl group, n-octyl group, isooctyl group, n-nonyl group, isononyl group, n-decyl group, isodecyl group, n-undecyl group, isoundecyl group, n-dodecyl group, isododecyl group, n-tridecyl group, isotridecyl group, n-tetradecyl group, isotetradecyl group, n-pentadecyl group, isopentadecyl group, n-hexadecyl group, and isohexadecyl group.

The aromatic ester compound incorporated in the composition for film formation of the present invention may be either the one synthesized by the method known in the art or the one available from a commercial source such as di-2-ethylhexyl phthalate available from Kanto Chemical Co., Inc., diisononyl phthalate available from Wako Pure Chemical Industries, dioctyl phthalate available from Tokyo Chemical Industry Co., Ltd., diisodecyl phthalate available from Wako Pure Chemical Industries, tris(2-ethylhexyl) trimellitate available from ALDRICH, and UL80 (octyl pyromellitate ester) available from ADEKA.

In the present invention, the aromatic ester compound may be used alone or in combination of two or more compounds.

The aromatic ester compound incorporated in the composition for film formation of the present invention may be used at any non-limiting content. However, the aromatic ester compound is preferably used at 0.1 to 30.0% by weight, more preferably at 1.0 to 20.0% by weight, and most preferably at 5.0 to 15.0% by weight in relation to the entire solid content of the composition. The term “solid content” corresponds to the entire solid content of the film obtained by coating this composition for film formation, and components such as organic solvents which will not remain in the resulting film are not included in the solid content.

It should be noted that, in terms of the excellent resistance to cracking, the composition for film formation of the present invention preferably contains 15.0 to 30.0% by weight of the aromatic ester compound in relation to the entire solid content of the composition.

### [Compound Having a Cage Structure]

The term “cage structure” as used herein means a molecule which has a cavity that is defined by a plurality of rings formed of covalently bonded atoms and in which any point positioned within the cavity cannot leave the cavity without passing through the rings. For example, an adamantane structure may be considered a cage structure. On the other hand, a cyclic structure having a single crosslinkage, for example, norbornane(bicyclo[2.2.1]heptane) cannot be considered a cage structure because the ring of the single-crosslinked cyclic compound does not define a cavity.

[Cage Structure (a)]

An exemplary preferable cage structure is alicyclic hydrocarbon structure such as adamantane, biadamantane, diamantane, triamantane, tetramantane, and dodecahedrane (which is hereinafter referred to as the “cage structure (a)”).

As described above, exemplary cage structures (a) include adamantane, biadamantane, diamantane, triamantane, tetramantane, and dodecahedrane, and the preferred are adamantane, biadamantane and diamantane in view of reducing the dielectric constant.

The cage structure (a) of the present invention may have one or more substituents. Examples of such substituent include halogen atoms (such as fluorine, chlorine, bromine, and iodine atoms), linear, branched, or cyclic alkyl groups containing 1 to 10 carbon atoms (such as methyl, t-butyl, cyclopentyl, and cyclohexyl), alkenyl groups containing 2 to 10 carbon atoms (such as vinyl and propenyl), alkynyl groups containing 2 to 10 carbon atoms (such as ethynyl and phenylethynyl), aryl groups containing 6 to 20 carbon atoms (such as phenyl, 1-naphthyl, and 2-naphthyl), acyl groups containing 2 to 10 carbon atoms (such as benzoyl), alkoxycarbonyl groups containing 2 to 10 carbon atoms (such as methoxycarbonyl), carbamoyl groups containing 1 to 10 carbon atoms (such as N,N-diethylcarbamoyl), aryloxy groups containing 6 to 20 carbon atoms (such as phenoxy), arylsulfonyl groups containing 6 to 20 carbon atoms (such as phenylsulfonyl), nitro group, cyano group, and silyl groups (such as triethoxysilyl, methyldiethoxysilyl, and trivinylsilyl).

In the invention, the cage structure (a) is preferably divalent, trivalent, or tetravalent. In this case, a group to be coupled to the cage structure may be a monovalent or polyvalent substituent or a polyvalent linking group. The cage structure is preferably divalent or trivalent, and more preferably divalent.

The compound having the cage structure (a) of the present invention may be either a low molecular weight compound or a high molecular weight compound (such as a polymer), and it is preferably a polymer of a monomer having the cage structure (a). The term “monomer” means a monomer which will be a dimer or polymer by polymerization. The polymer may be either a homopolymer or a copolymer, and exemplary polymers include a homopolymer of the monomer having the cage structure (a), a copolymer of the monomer having the cage structure (a) with another copolymerizable compound, or a copolymer of two or more monomers each having the cage structure (a).

When the compound having the cage structure (a) is a polymer, it may preferably have an average molecular weight of 1,000 to 500,000, more preferably 2,000 to 200,000, and most preferably 3,000 to 100,000.

The polymerization of the monomer having the cage structure (a) occurs by a polymerizable group substituent on the monomer. The term “polymerizable group” as used herein means a reactive substituent which causes polymerization of a monomer. No limitation is imposed on the polymerization, but examples include radical polymerization, cationic polymerization, anionic polymerization, ring-opening polymerization, polycondensation, polyaddition, addition condensation, and polymerization in the presence of a transition metal catalyst.

The polymer having the cage structure (a) in the present invention is preferably a polymer of a monomer having a polymerizable carbon-carbon double bond or carbon-carbon triple bond. More preferably, the polymer having the cage structure (a) is a polymer of a compound represented by any one of the following general formulae (V) to (X):

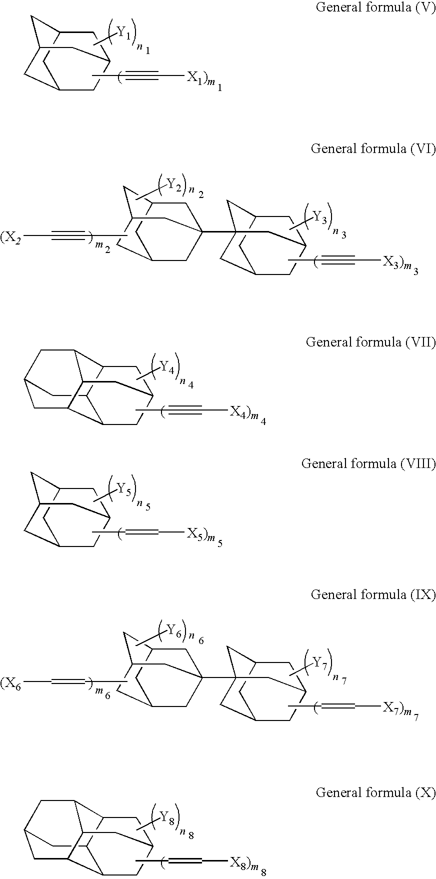

X₁ to X₈ independently represent hydrogen atom, an alkyl group containing 1 to 10 carbon atoms, an alkenyl group containing 2 to 10 carbon atoms, an alkynyl group containing 2 to 10 carbon atoms, an aryl group containing 6 to 20 carbon atoms, a silyl group containing 0 to 20 carbon atoms, an acyl group containing 2 to 10 carbon atoms, an alkoxycarbonyl group containing 2 to 10 carbon atoms, or a carbamoyl group containing 1 to 20 carbon atoms,

Y₁ to Y₈ independently represent a halogen atom, an alkyl group containing 1 to 10 carbon atoms, an aryl group containing 6 to 20 carbon atoms, or a silyl group containing 0 to 20 carbon atoms,

m₁ and m₅ independently represent an integer of 1 to 16, and n₁ and n₅ independently represent an integer of 0 to 15,

m₂ and m₃, m₆, and m₇ independently represent an integer of 1 to 15, and n₂, n₃, n₆, and n₇ independently represent an integer of 0 to 14, and

m₄ and m₈ independently represent an integer of 1 to 20, and n₄ and n₈ independently represent an integer of 0 to 19.

More particularly, X₁ to X₈ in the general formulae (V) to (X) are independently, hydrogen atom, an alkyl group containing 1 to 10 carbon atoms (such as methyl, ethyl, propyl, isopropyl, t-butyl, hexyl, or 2-ethylhexyl), an alkenyl group having 2 to 10 carbon atoms (such as vinyl, allyl, or 2-buten-1-yl), an alkynyl group having 2 to 10 carbon atoms (such as ethynyl, propargyl, or 1-butyn-4-yl), an aryl group having 6 to 20 carbon atoms (such as phenyl, p-tolyl, or 1-naphthyl), a silyl group having 0 to 20 carbon atoms (such as trimethylsilyl, t-butyldimethylsilyl, diethoxymethylsilyl, or dimethoxymethylsilyl), an acyl group having 2 to 10 carbon atoms (such as acetyl, isobutyryl, or benzoyl), an alkoxycarbonyl group having 2 to 10 carbon atoms (such as methoxycarbonyl or ethoxycarbonyl), a carbamoyl group having 1 to 20 carbon atoms (such as carbamoyl, N-methylcarbamoyl, or N,N-diethylcarbamoyl). Among these, X₁ to X₈ are preferably hydrogen atom, an alkyl group having 1 to 10 carbon atoms, an aryl group having 6 to 20 carbon atoms, a silyl group having 0 to 20 carbon atoms, an acyl group having 2 to 10 carbon atoms, an alkoxycarbonyl group having 2 to 10 carbon atoms, or a carbamoyl group having 1 to 20 carbon atoms, more preferably hydrogen atom or an aryl group having 6 to 20 carbon atoms, and most preferably hydrogen atom.

Y₁ to Y₈ are independently a halogen atom (such as fluorine atom, chlorine atom, or bromine atom), an alkyl group containing 1 to 10 carbon atoms, an aryl group containing 6 to 20 carbon atoms, or a silyl group containing 0 to 20 carbon atoms, more preferably an optionally substituted alkyl group containing 1 to 10 carbon atoms, or aryl group containing 6 to 20 carbon atoms, and most preferably an alkyl group (such as methyl group).

X₁ to X₈ and Y₁ to Y₈ may be substituted with another substituent. Exemplary such substituents include a halogen atom (fluorine atom, chlorine atom, bromine atom, or iodine atom), a linear, branched, or cyclic alkyl group (containing 1 to 20 carbon atoms and preferably containing 1 to 10 carbon atoms such as methyl, t-butyl, cyclopentyl, cyclohexyl, adamantyl, biadamantyl, or diamantyl), an alkynyl group (containing 2 to 10 carbon atoms such as ethynyl or phenyl ethynyl), an aryl group (containing 6 to 10 carbon atoms such as phenyl, 1-naphthyl, or 2-naphthyl), an acyl group (containing 1 to 10 carbon atoms such as acetyl or benzoyl), an aryloxy group (containing 6 to 10 carbon atoms such as phenoxy), an aryl sulfonyl group (containing 6 to 10 carbon atoms such as phenylsulfonyl), nitro group, cyano group, a silyl group (containing 1 to 10 carbon atoms such as triethoxysilyl, methyldiethoxysilyl, or trivinyl silyl), an alkoxycarbonyl group (containing 2 to 10 carbon atoms such as methoxycarbonyl), or a carbamoyl group (containing 1 to 10 carbon atoms such as carbamoyl or N,N-dimethylcarbamoyl).

m₁ and m₅ are independently an integer of 1 to 16, preferably 1 to 4, more preferably 1 to 3, and most preferably 2. n₁ and n₅ are independently an integer of 0 to 15, preferably 0 to 4, more preferably 0 or 1, and most preferably 0. m₂, m₃, m₆, and m₇ are independently an integer of 1 to 15, preferably 1 to 4, more preferably 1 to 3, and most preferably 2. n₂, n₃, n₆, and n₇ are independently an integer of 0 to 14, preferably 0 to 4, more preferably 0 or 1, and most preferably 0. m₄ and m₈ are independently an integer of 1 to 20, preferably 1 to 4, more preferably 1 to 3, and most preferably 2. n₄ and n₈ are independently an integer of 0 to 19, preferably 0 to 4, more preferably 0 or 1, and most preferably 0.

The monomer having a cage structure (a) used in the present invention is preferably a compound represented by the general formula (VI), general formula (VII), general formula (IX), or general formula (X), more preferably a compound represented by the general formula (VI) or general formula (VII), and most preferably a represented by the general formula (VII).

Examples of the monomer having the cage structure (a) which may be used in the present invention are shown below. These monomers, however, by no means limit the scope of the present invention.

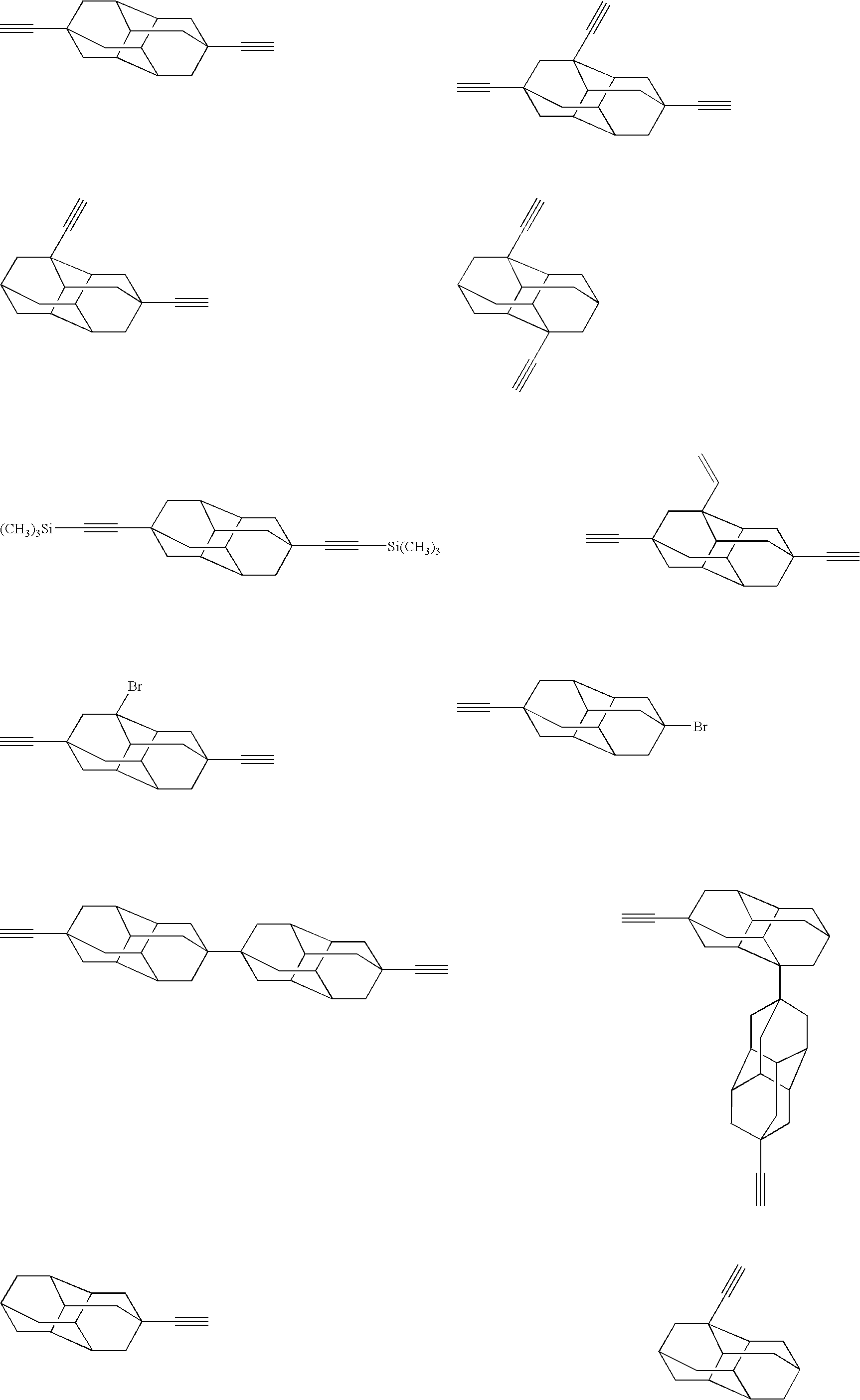

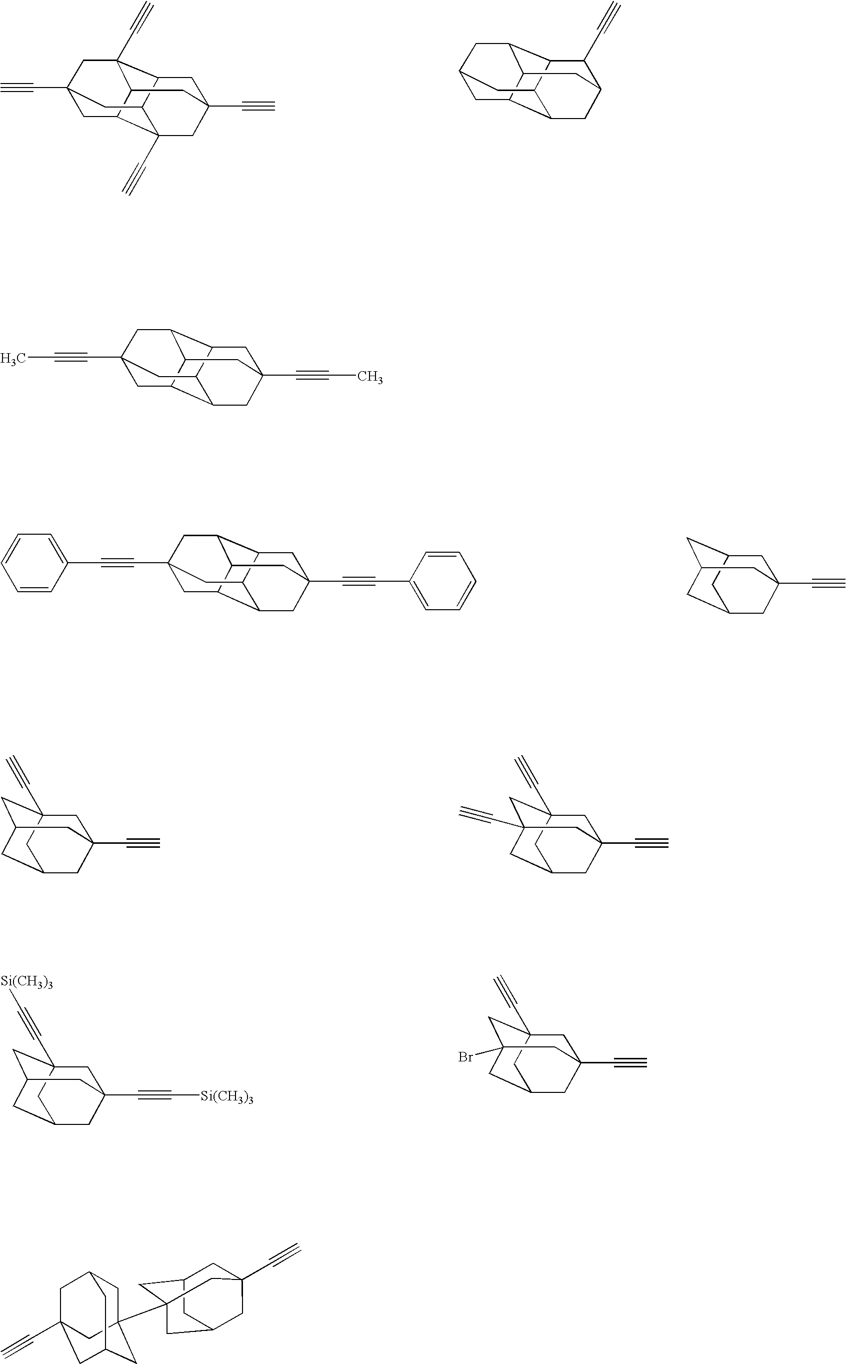

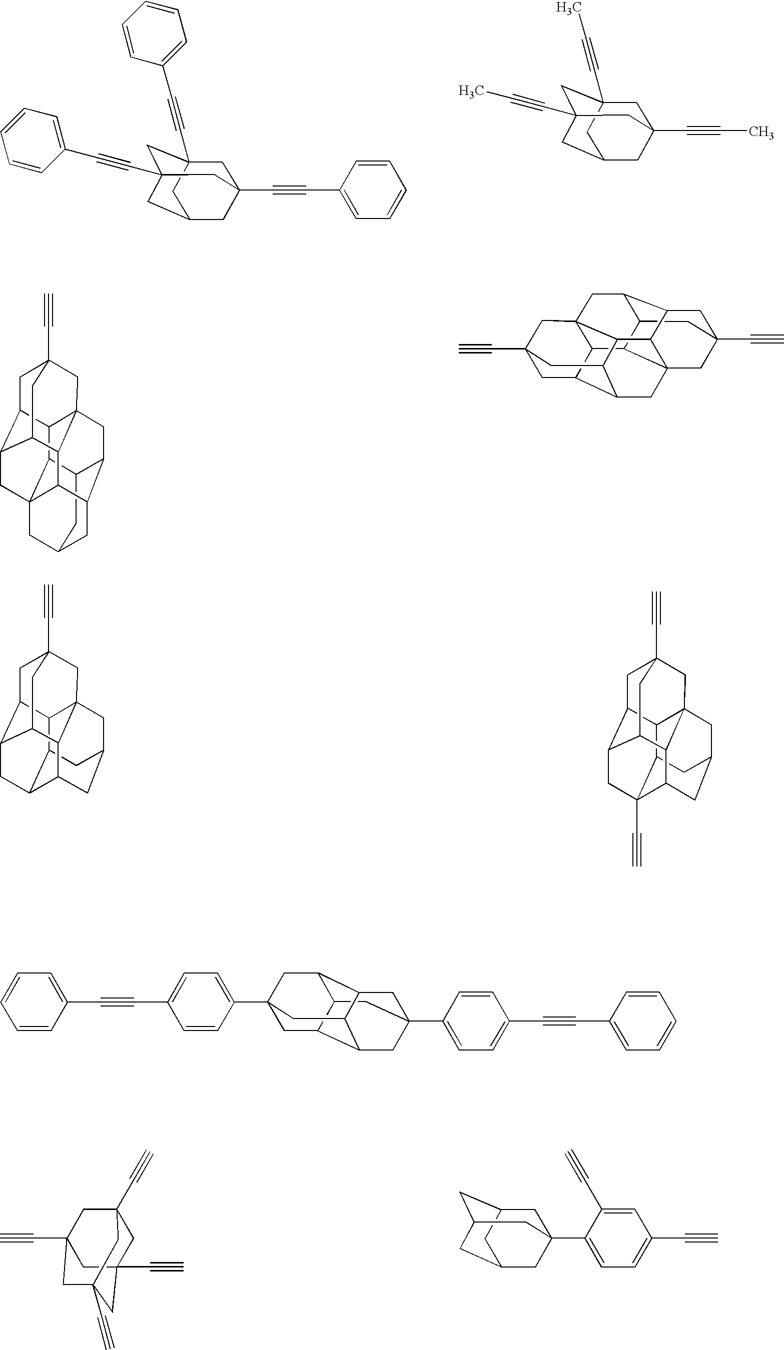

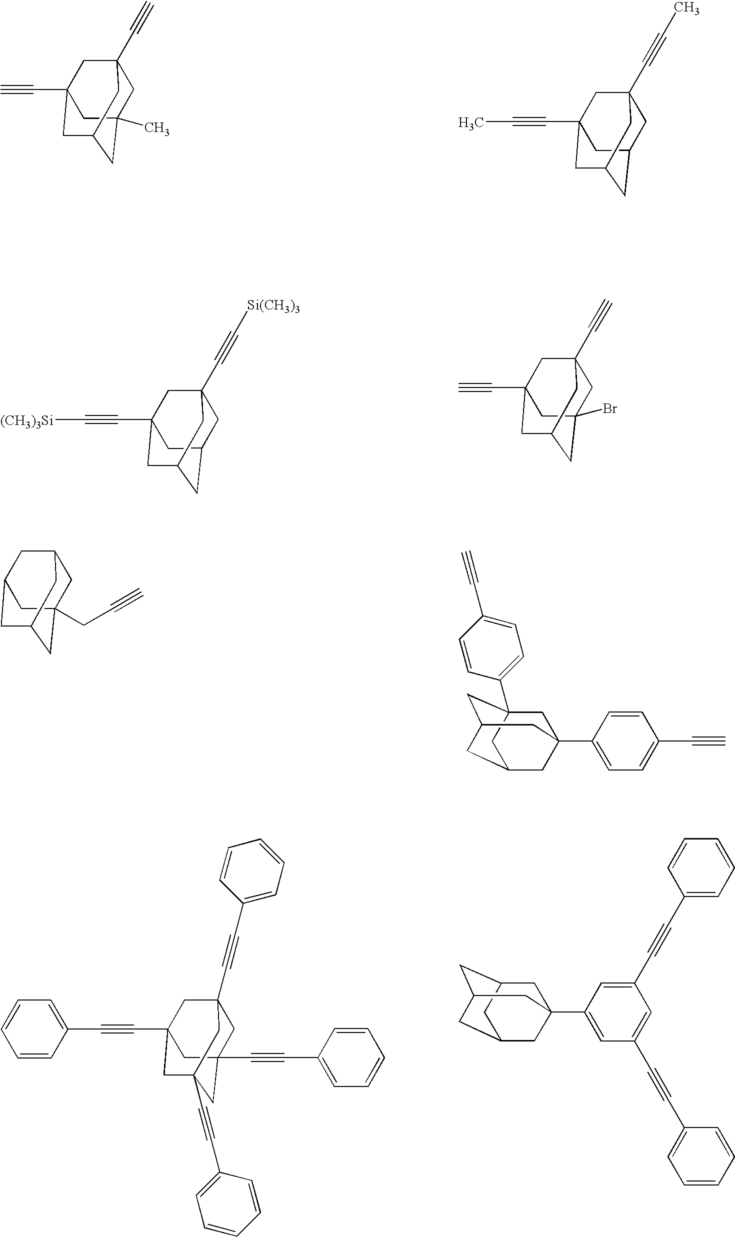

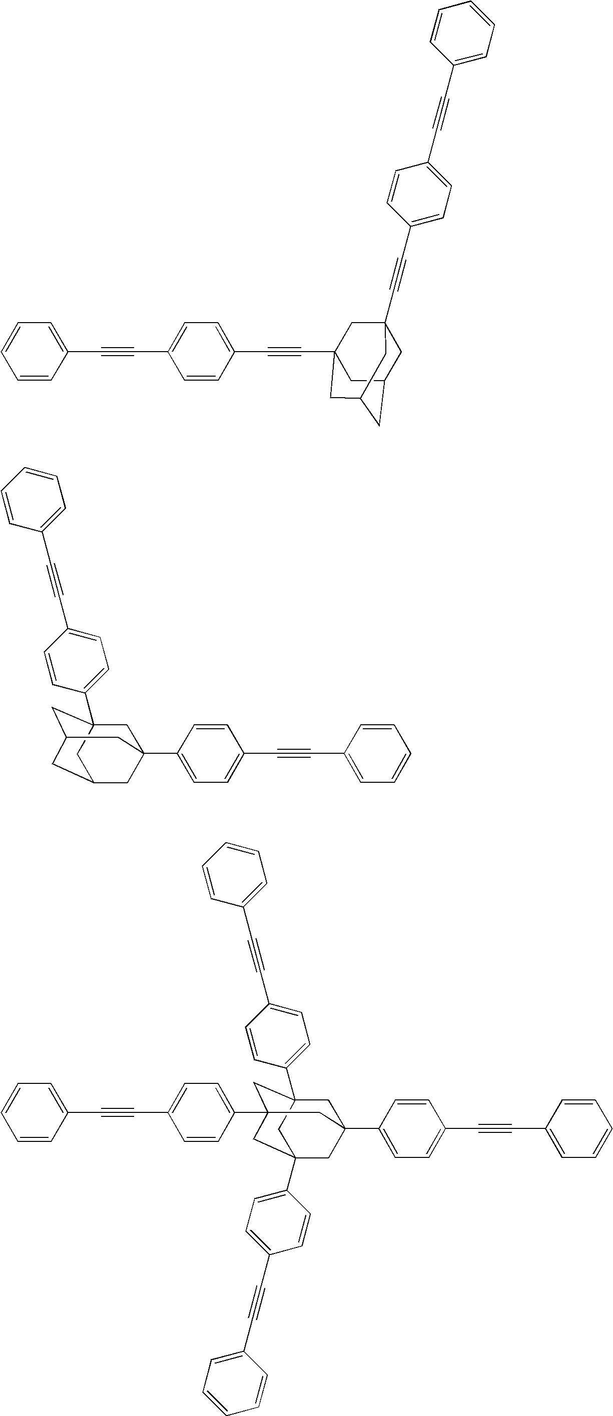

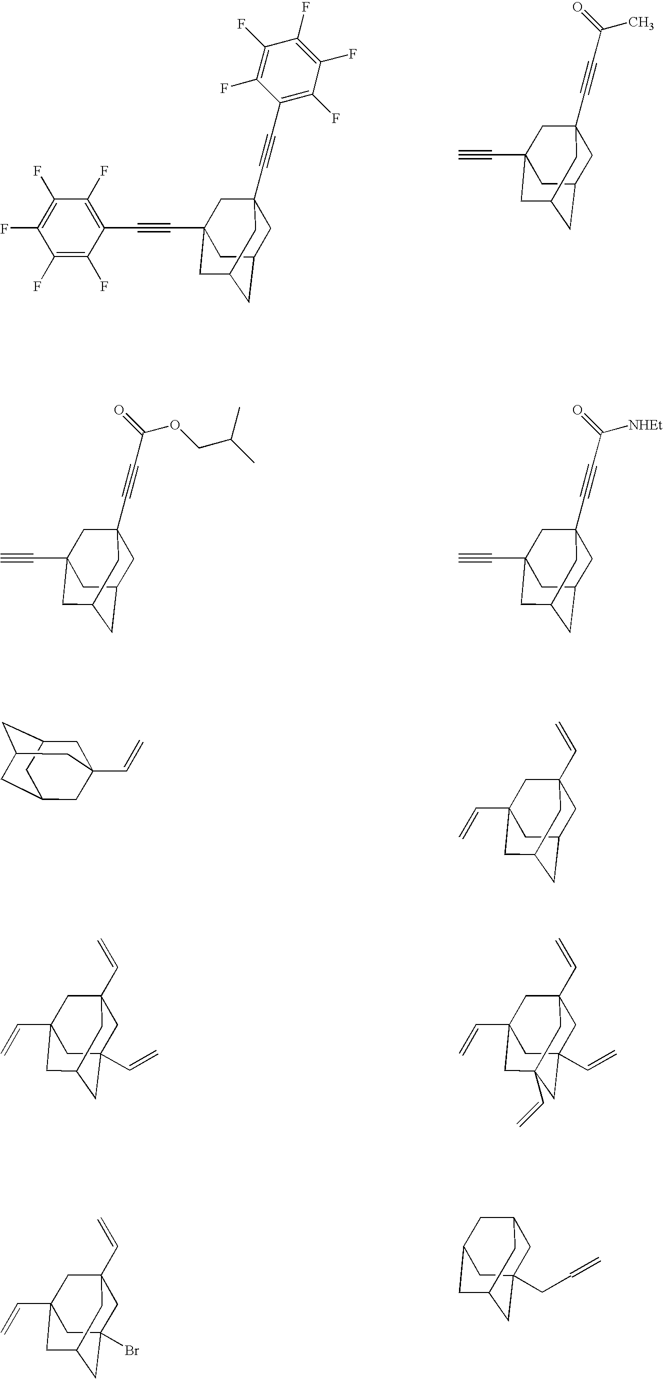

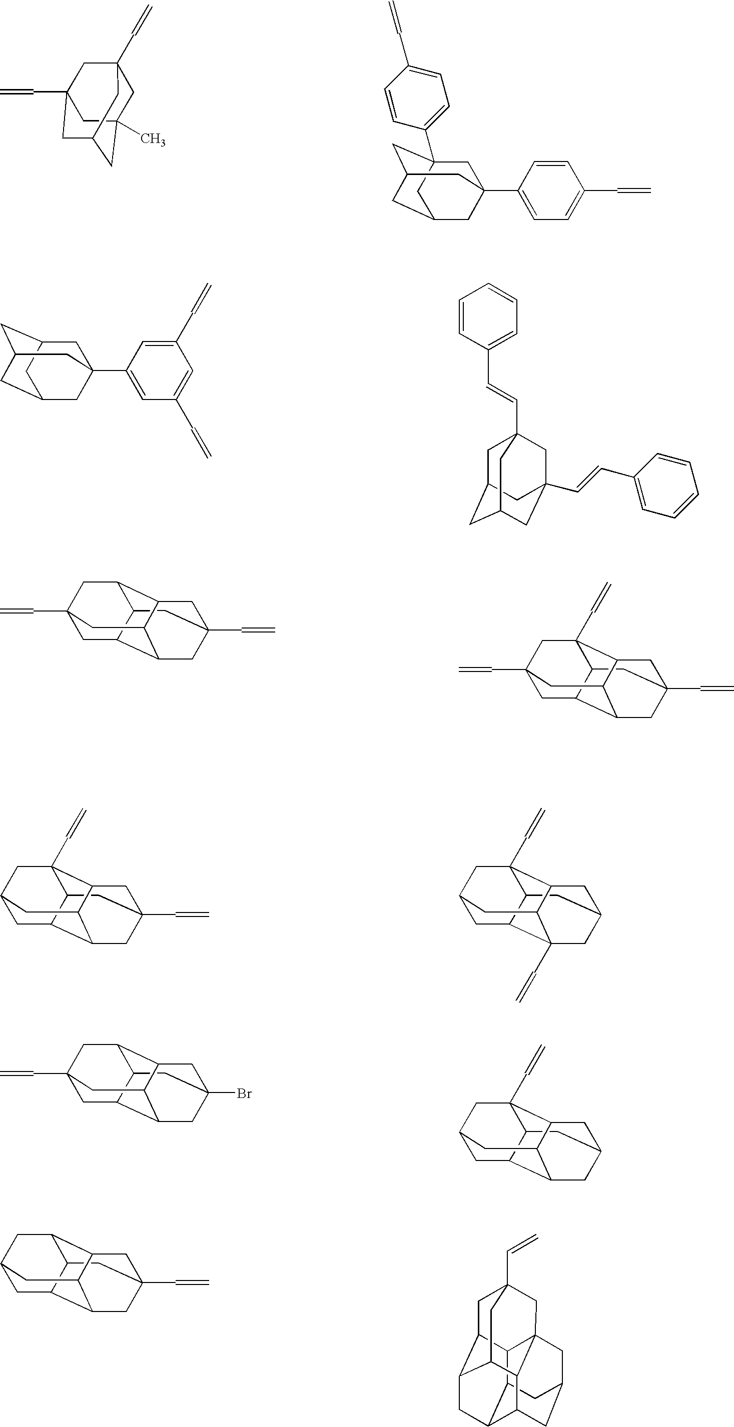

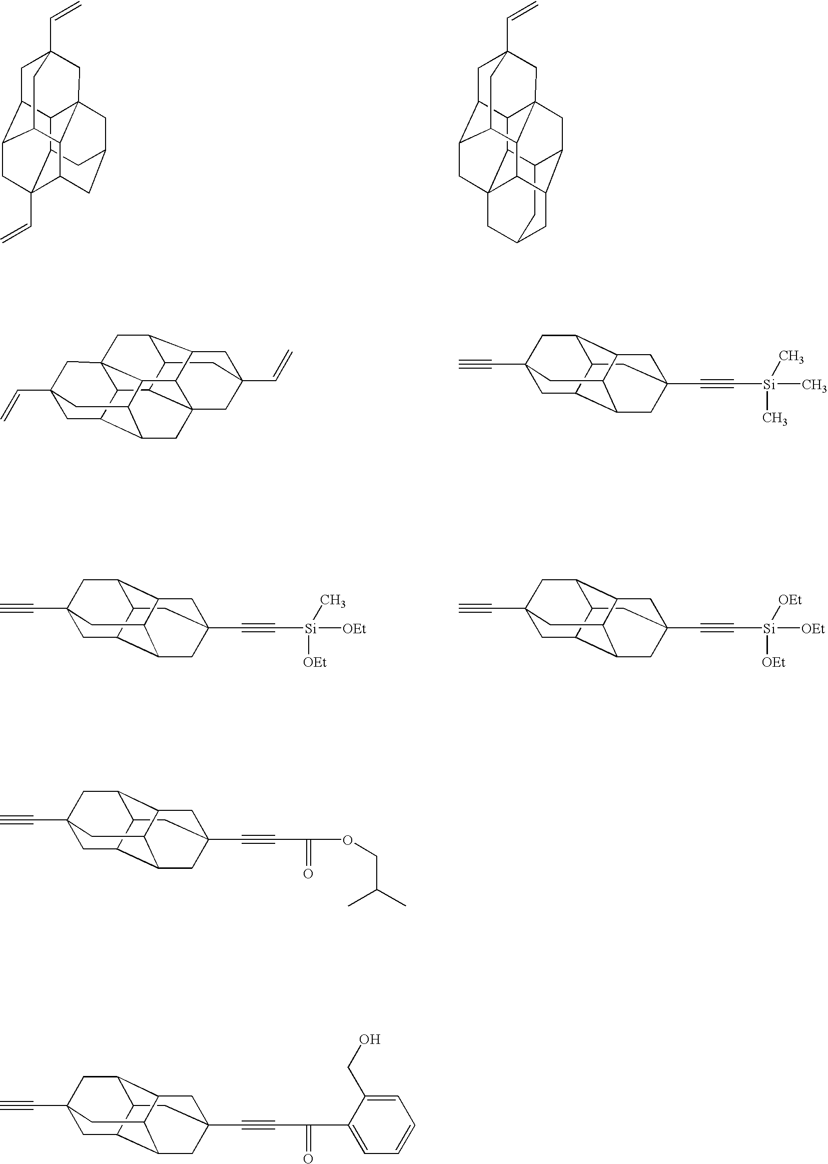

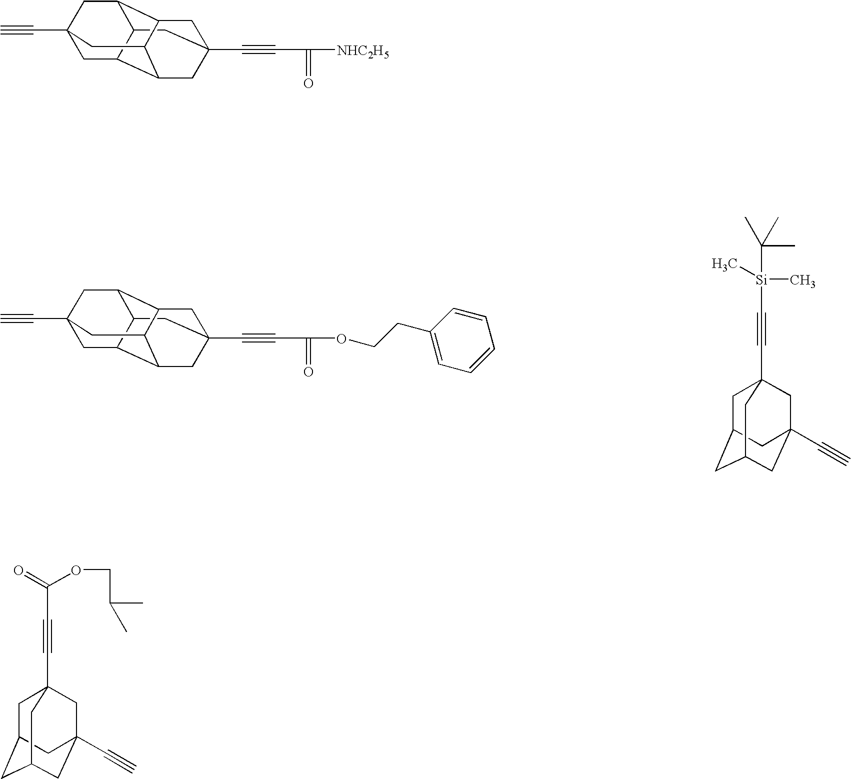

Of the monomers having a cage structure which may be used in the present invention, the monomer having carbon-carbon triple bond may be synthesized by using a commercially available diamantane for the starting material, and reacting the diamantane with bromine in the presence or absence of an aluminum bromide catalyst to introduce the bromine atom to the desired position; reacting with vinyl bromide by Friedel-Crafts reaction in the presence of a Lewis acid such as aluminum bromide, aluminum chloride, or iron chloride to introduce 2,2-dibromoethyl group; and subsequently removing HBr by using a strong base for conversion into the ethynyl group. More specifically, such monomer may be synthesized by the process described in Macromolecules, vol. 24, pages 5266 to 5268 (1991), Macromolecules, vol. 28, pages 5554 to 5560 (1995), or Journal of Organic Chemistry, vol. 39, pages 2995-3003 (1974). The monomer having the carbon-carbon double bond can be readily produced by reducing a monomer having ethynyl group, for example, with diisobutyl aluminum hydride (DIBAL-H).

Alternatively, hydrogen atom of the terminal acetylene group may be substituted with an anion, for example, by using butyl lithium, and an alkyl group or a silyl group may be introduced by further reacting with an alkyl halide or a silyl halide.

### [Polymerization Reaction]

The polymerization of the monomer having the cage structure (a) in the present invention is preferably conducted in the presence of a nonmetallic polymerization initiator. For example, a monomer having a polymerizable carbon-carbon double bond or carbon-carbon triple bond may be polymerized in the presence of a polymerization initiator which is activated by heating to generate a free radical such as carbon radical or oxygen radical.

The polymerization initiator may be an organic peroxide or an organic azo compound, the most preferred being the organic peroxide.

Preferable examples of the organic peroxide include ketone peroxides such as “PERHEXA H”, peroxyketals such as “PERHEXA TMH”, hydroperoxides such as “PERBUTYL H-69”, dialkyl peroxides such as “PERCUMYL D”, “PERBUTYL C”, and “PERBUTYL D”, diacyl peroxides such as “NYPER BW”, peroxyesters such as “PERBUTYL Z” and “PERBUTYL L”, and peroxydicarbonates such as “PEROYL TCP”, (which are commercially available from NOF Corporation).

Preferable examples of the organic azo compounds include azonitrile compounds such as “V-30”, “V-40”, “V-59”, “V-60”, “V-65”, and “V-70”, azoamide compounds such as “VA-080”, “VA-085”, “VA-086”, “VF-096”, “VAm-110”, and “VAm-111”, cyclic azoamidine compounds such as “VA-044” and “VA-061”, and azoamidine compounds such as “V-50” and VA-057” (which are commercially available from Wako Pure Chemical Industries).

The polymerization initiator for the monomer having the cage structure (a) used may be one such compound or a mixture of two or more such compounds, and the polymerization initiator is preferably used at an amount of 0.001 to 2 mole, more preferably at 0.01 to 1 mole, and most preferably at 0.05 to 0.5 mole per 1 mole of the monomer.

The polymerization of the monomer having the cage structure (a) in the present invention may be conducted in the presence of a transition metal catalyst. For example, the monomer having a polymerizable carbon-carbon double bond or carbon-carbon triple bond may be polymerized by using a Pd catalyst such as Pd(PPh₃)₄ or Pd(OAc)₂, a Ziegler-Natta catalyst, a Ni catalyst such as nickel acetylacetonate, a W catalyst such as WCl₆, a Mo catalyst such as MoCl₅, a Ta catalyst such as TaCls, a Nb catalyst such as NbCl₅, a Rh catalyst, or a Pt catalyst.

The transition metal catalyst used may be one such compound or a mixture of two or more such compounds, and the transition metal catalyst is preferably used at an amount of 0.001 to 2 mole, preferably at 0.01 to 1 mole, and more preferably at 0.05 to 0.5 mole per 1 mole of the monomer.

For the polymerization, any solvent may be used as long as it can dissolve the starting monomer at the required concentration and it does not adversely affect the properties of the film formed from the resulting polymer. Exemplary such solvents include water; alcohol solvents such as methanol, ethanol and propanol; ketone solvents such as alcohol-acetone, methyl ethyl ketone, methyl isobutyl ketone, cyclohexanone, and acetophenone; ester solvents such as ethyl acetate, butyl acetate, propylene glycol monomethyl ether acetate, γ-butyrolactone, and methyl benzoate; ether solvents such as dibutyl ether and anisole; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene, and 1,3,5-triisopropylbenzene; amide solvents such as N-methylpyrrolidone and dimethylacetamide; halogen solvents such as carbon tetrachloride, dichloromethane, chloroform, 1,2-dichloroethane, chlorobenzene, 1,2-dichlorobenzene, and 1,2,4-trichlorobenzene; and aliphatic hydrocarbon solvents such as hexane, heptane, octane, and cyclohexane.

Of these solvents, the preferred are acetone, methyl ethyl ketone, methyl isobutyl ketone, cyclohexanone, acetophenone, ethyl acetate, propylene glycol monomethyl ether acetate, γ-butyrolactone, anisole, tetrahydrofuran, toluene, xylene, mesitylene, 1,2,4,5-tetramethylbenzene, isopropylbenzene, t-butylbenzene, 1,4-di-t-butylbenzene, 1,3,5-tri-t-butylbenzene, 4-t-butyl-orthoxylene, 1-methylnaphthalene, 1,3,5-triisopropylbenzene, 1,2-dichloroethane, chlorobenzene, 1,2-dichlorobenzene, and 1,2,4-trichlorobenzene; and the more preferred are tetrahydrofuran, γ-butyrolactone, anisole, toluene, xylene, mesitylene, isopropylbenzene, t-butylbenzene, 1,3,5-tri-t-butylbenzene, 1-methylnaphthalene, 1,3,5-triisopropylbenzene, 1,2-dichloroethane, chlorobenzene, 1,2-dichlorobenzene, and 1,2,4-trichlorobenzene. The most preferred are γ-butyrolactone, anisole, mesitylene, t-butylbenzene, 1,3,5-triisopropylbenzene, 1,2-dichlorobenzene, and 1,2,4-trichlorobenzene. These solvents may be used either alone or in combination of two or more. Concentration of the monomer in the reaction mixture is preferably in the range of 1 to 50% by weight, more preferably 5 to 30% by weight, and most preferably 10 to 20% by weight.

The optimal conditions of the polymerization may vary by the type and concentration of the polymerization initiator, the monomer, and the solvent. The polymerization, however, is preferably effected at an internal temperature of from 0 to 200° C., more preferably at 50 to 170° C., and most preferably at 100 to 150° C. for a polymerization time of preferably 1 to 50 hours, more preferably 2 to 20 hours, and most preferably 3 to 10 hours.

The polymerization is preferably conducted in an inert gas atmosphere (for example, in nitrogen or argon) in order to suppress the inactivation of the polymerization initiator which may otherwise promoted by oxygen. The reaction is preferably conducted at an oxygen concentration of up to 100 ppm, more preferably up to 50 ppm, and most preferably up to 20 ppm.

The cage structure (a) in the present invention may be present as a pendant group in a polymer or as a part of the backbone of a polymer, the latter being the preferred. When the cage structure (a) is a part of the backbone, the polymer chain will be cleaved by the removal of the cage structure (a) from the polymer. In such case, the cage structure (a) is either directly bonded by a single bond or by an adequate divalent linking group to the polymer. Examples of the linking group include —C(R₁₁)(R₁₂)—, —C(R₁₃)═C(R₁₄)—, —C≡C—, an arylene group, —CO—, —O—, —SO₂—, —N(R₁₅)—, —Si(R₁₆)(R₁₇)—, and combinations thereof, wherein R₁₁ to R₁₇ independently represent hydrogen atom, an alkyl group, an alkenyl group, an alkynyl group, or an aryl group, which may be optionally substituted with a substituent. Preferable examples of such substituent are as mentioned above.

Among these, the linking group is preferably —C(R₁₁)(R₁₂)—, —CH═CH—, —C≡C—, an arylene group, —O—, —Si(R₁₆)(R₁₇)—, or a combination thereof, and most preferably —C(R₁₁)(R₁₂)— or —CH═CH— in view of the low dielectric constant.

Examples of the compound having a cage structure (a) of the present invention include polybenzoxazole disclosed in JP 11-322929 A, JP 2003-12802 A, and JP 2004-18593 A; quinoline resin disclosed in JP 2001-2899 A; polyaryl resin disclosed in JP 2003-530464 A, JP 2004-535497 A, JP 2004-504424 A, JP 2004-504455 A, JP 2005-501131 A, JP 2005-516382 A, JP 2005-514479 A, JP 2005-522528 A, JP 2000-100808 A, and U.S. Pat. No. 6,509,415 A; polyadamantane disclosed in JP 11-214382 A, JP 2001-332542 A, JP 2003-252982 A, JP 2003-292878 A, JP 2004-2787 A, JP 2004-67877 A, and JP 2004-59444 A; and polyimide disclosed in JP 2003-252992 A and JP 2004-26850 A.

The compound having a cage structure (a) of the present invention may preferably have a sufficient solubility in an organic solvent. Preferably, the compound having the cage structure (a) has a solubility in cyclohexanone or anisole at 25° C. of at least 3% by weight, more preferably at least 5% by weight, and most preferably at least 10% by weight.

In the present invention, two or more compounds having a cage structure (a) may be simultaneously used, or a copolymer having two or more monomers having the cage structure (a) copolymerized therein may also be used.

[Cage Structure (b)]

The compound having a cage structure incorporated in the composition for film formation of the present invention may also be a polymer of a monomer having a cage structure formed by m RSi(O_{0.5})₃ units (wherein m represents an integer of 8 to 16, and R independently represents a non-hydrolyzable group with the proviso that at least two R represent a group containing vinyl group or ethynyl group), each unit being connected to another unit by sharing the oxygen atom in the unit (the cage unit being hereinafter referred to as the “cage structure (b)”). The compound (monomer) having a cage structure (b) is also called as a cage silsesquioxane. Silsesquioxane is a term used to generally refer to a compound having a structure wherein each silicon atom is bonded to 3 oxygen atoms, and each oxygen atom is bonded to 2 silicon atoms (namely, wherein number of the oxygen atom to the silicon atom is 1.5).

R represents a non-hydrolyzable group. The term “non-hydrolyzable group” as used herein means a group at least 95% of which remains unreacted when brought in contact with the equimolar amount of neutral water at room temperature for 1 hour. Of the R, at least two R are a group containing vinyl group or ethynyl group. Exemplary non-hydrolyzable groups R include optionally substituted hydrocarbon groups, silicon atom-containing groups, and groups comprising a combination of such groups. Exemplary hydrocarbon groups include aliphatic hydrocarbon groups and aryl groups, and exemplary aliphatic hydrocarbon groups include an alkyl group, an alkenyl group, and an alkynyl group. R may be the same or different.

The alkyl group is not particularly limited, and it may be a linear, branched, or cyclic group preferably containing 1 to 6, and more preferably 1 to 2 carbon groups such as methyl group, tert-butyl group, cyclopentyl group, cyclohexyl group, ethyl group, and pentyl group, and more preferably methyl group and ethyl group.

The alkenyl group is not particularly limited, and it may be a linear, branched, or cyclic group preferably containing 1 to 6, and more preferably 1 to 2 carbon groups such as vinyl group and allyl group, and more preferably vinyl group.

The alkynyl group is not particularly limited, and it may be a linear, branched, or cyclic group preferably containing 1 to 6, and more preferably 1 to 2 carbon groups such as ethynyl group.

The aryl group is not particularly limited as long as it is an aromatic ring, and it may contain 1 to 10, and more preferably 1 to 6 carbon atoms. The aryl group may also contain a substituent. Exemplary aryl groups include phenyl group and naphthyl group, and preferably phenyl group.

The silicon atom-containing group is not particularly limited as long as it contains silicon. However, the silicon atom-containing group is a group represented by the general formula (2):

*-L₁-Si—(R₂₀)₃ General formula (2)

wherein L₁ represents an alkylene group, —O—, —S—, —Si (R₂₁)(R₂₂)—, —N(R₂₃)—, or a divalent linking group comprising a combination of such groups. R₂₁, R₂₂, R₂₃, and R₂₀ independently represent an alkyl group, an alkenyl group, or an alkynyl group. * represents binding position of the silicon atom.

In the general formula (2), L₁ represents an alkylene group, —O—, —S—, —Si (R₂₁)(R₂₂)—, —N(R₂₃)—, or a divalent linking group comprising a combination of such groups, and preferably an alkylene group, —O—, or a divalent linking group comprising a combination of such groups. The alkylene group is preferably the one containing 1 to 6, and more preferably 1 to 2 carbon atoms.

In the general formula (2), the alkyl group, the alkenyl group, and the alkynyl group represented by R₂₁, R₂₂, R₂₃, and R₂₀ are as defined above for the R, and exemplary such groups include methyl group, vinyl group, and ethynyl group.

The group containing vinyl group or ethynyl group is preferably vinyl group, ethynyl group, or a group represented by the general formula (3):

*-L₂-R₃₀ General formula (3)

and more preferably, vinyl group or ethynyl group in view of ease of controlling the molecular weight. In the general formula (3), L₂ represents —CO—, —O—, —S—, —[C(R₃₁)(R₃₂)]ₖ—, —N(R₃₃)—, or a divalent linking group comprising a combination of such groups. R₃₁ to R₃₃ independently represent hydrogen atom, methyl group, or ethyl group, k represents an integer of 1 to 6, and R₃₀ represents vinyl group or ethynyl group. * represents binding position of the silicon atom.

In the general formula (3), L₂ represents —CO—, —O—, —S—, —[C(R₃₁)(R₃₂)]ₖ—, —N(R₃₃)—, or a divalent linking group comprising a combination of such groups. Among these, L₂ is preferably —[C(R₃₁)(R₃₂)]ₖ—, —O—, or a divalent linking group comprising a combination of such groups.

Of the R in the cage structure (b), at least 2 vinyl groups are preferably directly bonded to the silicon atom having R bonded thereto, and in view of the film properties such as mechanical strength, at least 4 of the R are preferably vinyl group, and most preferably, all of the R are vinyl group.

The monomer having the cage structure (b) is preferably a compound represented by the general formulae (Q-1) to (Q-6), and of these compounds, the more preferred is the compound represented by the general formula (Q-6) in view of availability and ease of controlling the polymerization process.

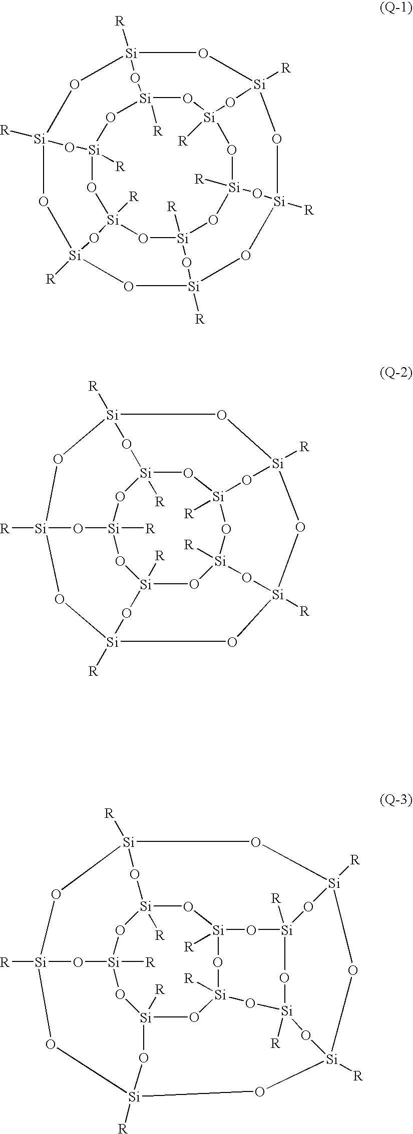

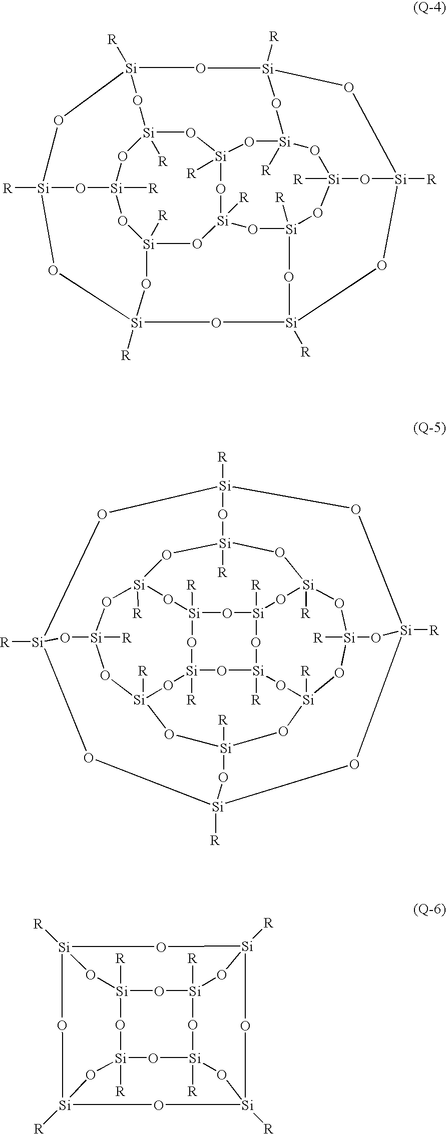

In the general formulae (Q-1) to (Q-6), R represents a non-hydrolyzable group, and at least 2 of the R are groups containing either vinyl group or ethynyl group. Examples of the R are the same as those as mentioned above.

The non-limiting examples of the monomer having the cage structure (b) include those as shown below.

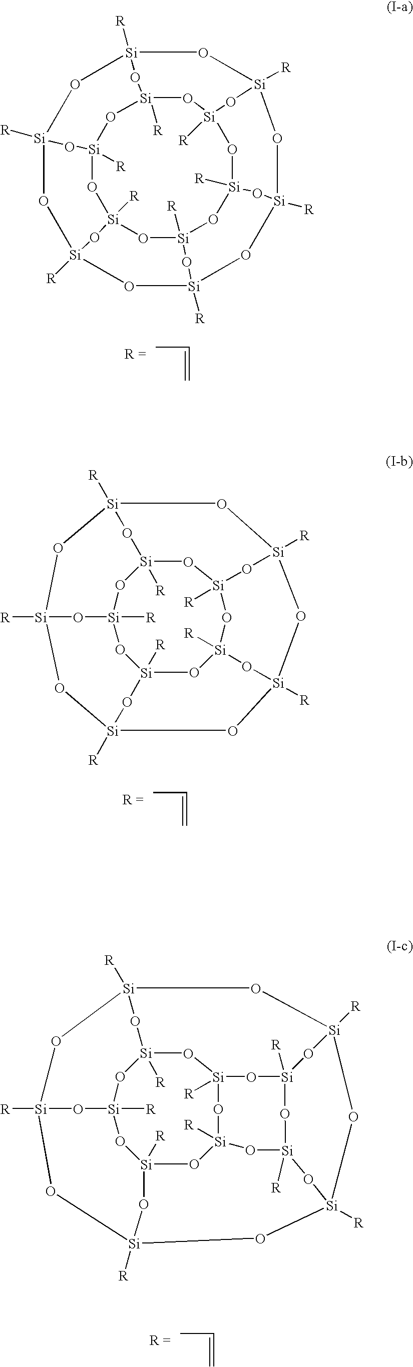

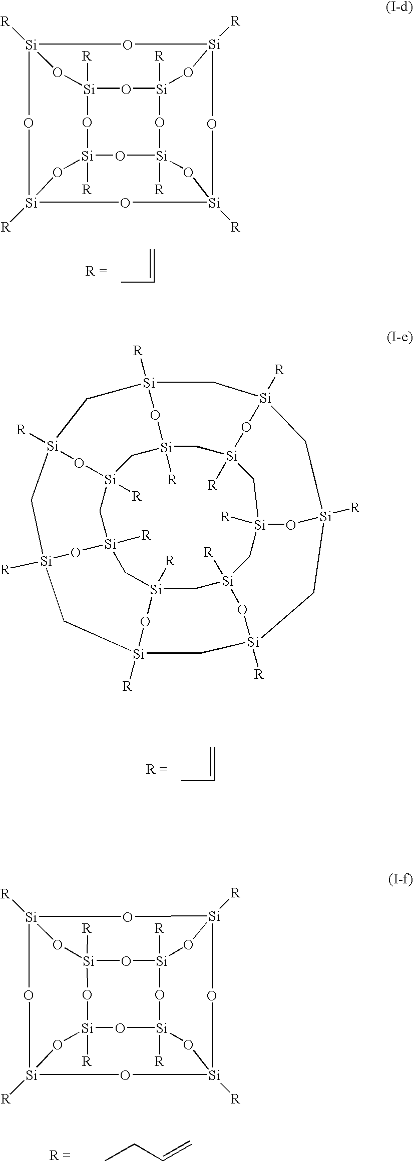

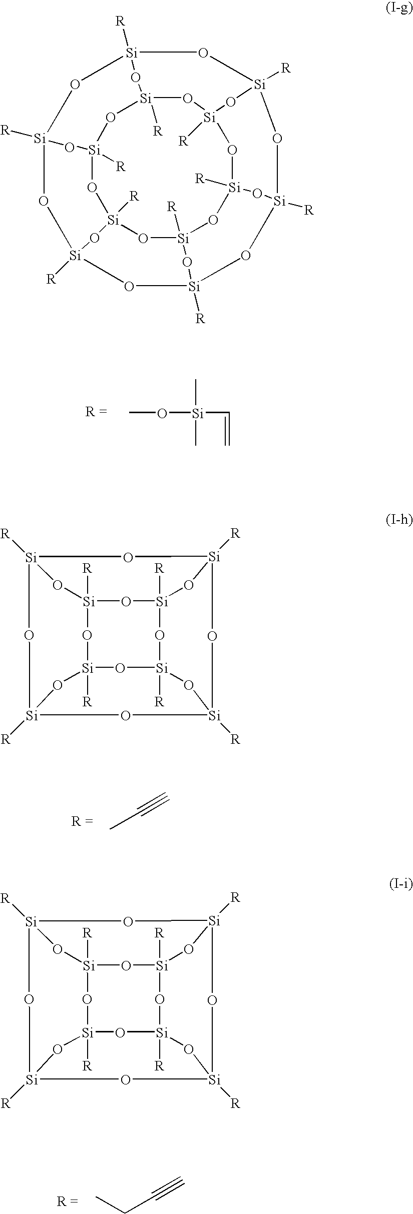

The monomer having the cage structure (b) used in the present invention may be either the one purchased from a commercial source or the one synthesized by the method known in the art.

The composition for film formation of the present invention may contain a polymer of a plurality of different monomers having the cage structure (b). In such case, the polymer may be a copolymer comprising a plurality of different monomers having the cage structure (b), or a mixture of homopolymers. When the composition for film formation of the present invention contains a copolymer comprising a plurality of different monomers having the cage structure (b), the copolymer is preferably a copolymer of a mixture of two or more monomers having the cage structure (b) wherein m is selected from 8, 10, and 12.

Alternatively, a copolymer of a monomer having the cage structure (b) with another monomer may be used as a polymer compound. The monomer incorporated in such a case in the copolymer with the monomer having the cage structure (b) is preferably a compound having two or more polymerizable carbon-carbon unsaturated bond. Examples of such monomer include a vinylsilane, a vinylsiloxane, a phenylacetylene, and the monomer represented by any one of the general formulae (V) to (X).

The synthesis of the polymer comprising the monomer having the cage structure (b) is preferably accomplished by dissolving the monomer as described above in a solvent, and allowing the vinyl group or the like to react by the addition of the polymerizing initiator. No limitation is imposed on the polymerization, and the polymerization may be accomplished, for example, by radical polymerization, cationic polymerization, anionic polymerization, ring-opening polymerization, polycondensation, polyaddition, addition condensation, or polymerization in the presence of a transition metal catalyst.

The polymerization of the monomer having the cage structure (b) is preferably conducted in the presence of a nonmetallic polymerization initiator. For example, a monomer may be polymerized in the presence of a polymerization initiator which is activated by heating to generate a free radical such as carbon radical or oxygen radical.

The polymerization initiator may be an organic peroxide or an organic azo compound, the most preferred being the organic peroxide.

Preferable examples of the organic peroxide include ketone peroxides such as “PERHEXA H”, peroxyketals such as “PERHEXA TMH”, hydroperoxides such as “PERBUTYL H-69”, dialkyl peroxides such as “PERCUMYL D”, “PERBUTYL C”, and “PERBUTYL D”, diacyl peroxides such as “NYPER BW”, peroxyesters such as “PERBUTYL Z” and “PERBUTYL L”, peroxydicarbonates such as “PEROYL TCP” which are commercially available from NOF Corporation, and LUPEROX commercially available from Arkema Yoshitomi, Ltd.

Preferable examples of the organic azo compounds include azonitrile compounds such as “V-30”, “V-40”, “V-59”, “V-60”, “V-65”, and “V-70”, azoamide compounds such as “VA-080”, “VA-085”, “VA-086”, “VF-096”, “VAm-110”, and “VAm-111”, cyclic azoamidine compounds such as “VA-044” and “VA-061”, and azoamidine compounds such as “V-50” and VA-057” (which are commercially available from Wako Pure Chemical Industries).

The polymerization initiator used for the polymerization of the monomer having the cage structure (b) may be one such compound or a mixture of two or more such compounds.

The polymerization initiator is preferably used at an amount of 0.001 to 2 mole, more preferably at 0.01 to 1 mole, and most preferably at 0.05 to 0.5 mole per 1 mole of the monomer.

For the polymerization of the monomer having the cage structure (b), any solvent may be used as long as it can dissolve the monomer at the required concentration and it does not adversely affect the properties of the film formed from the resulting polymer. Exemplary such solvents include water; alcohol solvents such as methanol, ethanol and propanol; ketone solvents such as acetone, methyl ethyl ketone, methyl isobutyl ketone, cyclohexanone, and acetophenone; ester solvents such as ethyl acetate, butyl acetate, propylene glycol monomethyl ether acetate, γ-butyrolactone, and methyl benzoate; ether solvents such as dibutyl ether, anisole, and tetrahydrofuran; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene, and 1,3,5-triisopropylbenzene; amide solvents such as N-methylpyrrolidone and dimethylacetamide; halogen solvents such as carbon tetrachloride, dichloromethane, chloroform, 1,2-dichloroethane, chlorobenzene, 1,2-dichlorobenzene, and 1,2,4-trichlorobenzene; and aliphatic hydrocarbon solvents such as hexane, heptane, octane, and cyclohexane.

Of these solvents, preferred are acetone, methyl ethyl ketone, methyl isobutyl ketone, cyclohexanone, acetophenone, ethyl acetate, butyl acetate, propylene glycol monomethyl ether acetate, γ-butyrolactone, anisole, tetrahydrofuran, toluene, xylene, mesitylene, 1,2,4,5-tetramethylbenzene, isopropylbenzene, t-butylbenzene, 1,4-di-t-butylbenzene, 1,3,5-tri-t-butylbenzene, 4-t-butyl-orthoxylene, 1-methylnaphthalene, 1,3,5-triisopropylbenzene, 1,2-dichloroethane, chlorobenzene, 1,2-dichlorobenzene, and 1,2,4-trichlorobenzene, of which the more preferred being tetrahydrofuran, γ-butyrolactone, anisole, toluene, xylene, mesitylene, isopropylbenzene, t-butylbenzene, 1,3,5-tri-t-butylbenzene, 1-methylnaphthalene, 1,3,5-triisopropylbenzene, 1,2-dichloroethane, chlorobenzene, 1,2-dichlorobenzene, and 1,2,4-trichlorobenzene. The most preferred are γ-butyrolactone, anisole, mesitylene, t-butylbenzene, 1,3,5-triisopropylbenzene, 1,2-dichlorobenzene, and 1,2,4-trichlorobenzene. These solvents may be used either alone or in combination of two or more.

Concentration of the monomer in the reaction mixture is preferably in the range of up to 30% by weight, more preferably up to 10% by weight, still more preferably up to 5% by weight, more preferably up to 1% by weight, and most preferably up to 1% by weight. By using a lower monomer concentration in the polymerization, the resulting composition will have a higher weight average molecular weight as well as higher number average molecular weight, and the composition will have a higher solubitlity in the organic solvent.

The optimal conditions for the polymerization of the monomer having the cage structure (b) may vary by the type and concentration of the polymerization initiator, the monomer, and the solvent. The polymerization, however, is preferably effected at an internal temperature of from 0 to 200° C., more preferably at 40 to 170° C., and most preferably at 70 to 150° C. for a polymerization time of preferably 1 to 50 hours, more preferably 2 to 20 hours, and most preferably 3 to 10 hours.

The polymerization is preferably conducted in an inert gas atmosphere (for example, in nitrogen or argon) in order to suppress the inactivation of the polymerization initiator which may otherwise promoted by oxygen. The reaction is preferably conducted at an oxygen concentration of up to 100 ppm, more preferably up to 50 ppm, and most preferably up to 20 ppm.

The polymer produced by the polymerization may preferably have a weight average molecular weight (Mw) of 1,000 to 1,000,000, more preferably 2,000 to 500,000, and most preferably 3,000 to 100,000.

Preferably, the polymer comprising the monomer having the cage structure (b) is soluble in an organic solvent. The term “soluble” as used herein means that the polymer is soluble at 25° C. in a solvent selected from cyclohexanone, methyl ethyl ketone, methyl isobutyl ketone, propylene glycol monomethyl ether acetate, propylene glycol monomethyl ether, and γ-butyrolactone at least at 5%. Preferably, the polymer is soluble at least 10% by weight and more preferably at least 20% by weight.

The degree of dispersion (Mw/Mn) of the monomer having the cage structure (b) calculated from the GPC chart is preferably 1 to 15, more preferably 1 to 10, and most preferably 1 to 5. When the Mw is the same, a film having lower density, refractive index, and dielectric constant can be formed when the degree of dispersion is low.

The method used for producing the polymer having such physical properties include using high dilution conditions, adding a chain transfer agent, optimizing the reaction solvent, continuously adding a polymerization initiator, continuously adding the monomer, and adding a radical trapping agent in the polymerization of the monomer having the cage structure (b).

The method used for producing the polymer having such physical properties also include filtration of the insoluble content, purification by using column chromatography, and purification by reprecipitation after the polymerization of the monomer having the cage structure (b).

The term “reprecipitation” as used herein means adding a poor solvent (which is a solvent into which the polymer of the present invention is substantially insoluble) to the reaction mixture which, if necessary, has the reaction solvent removed therefrom; or adding dropwise the reaction mixture which, if necessary, has the reaction solvent removed therefrom to the poor solvent to thereby precipitate the composition of the present invention and collecting the precipitate by filtration. Preferable poor solvents include alcohols such as methanol, ethanol, and isopropyl alcohol. The poor solvent is preferably used in an amount 1 to 200 times, and more preferably at 2 to 50 times the weight of the composition of the invention.

When the polymer compound comprising the monomer having the cage structure (b) is used, the polymer compound is preferably used after concentrating the polymer compound by removing the reaction solvent by distillation. The polymer compound is also preferably used after reprecipitation.

The concentration is preferably conducted by heating and/or reducing the pressure by using a rotary evaporator, a distillatory, or the reaction apparatus used for the polymerization. The temperature of the reaction mixture during the concentration is typically 0° C. to 180° C., preferably 10° C. to 140° C., more preferably 20° C. to 100° C., and most preferably 30° C. to 60° C. The pressure during the concentration is typically 0.001 Torr to 760 Torr, preferably 0.01 Torr to 100 Torr, and more preferably 0.01 Torr to 10 Torr.

In the concentration of the reaction mixture, concentration is preferably continued until the solid content in the reaction mixture is at least 10% by weight, more preferably at least 30% by weight, and most preferably at least 50% by weight.

In preparing the composition for film formation of the present invention, such polymer compound may be used either alone or in combination of two or more.

### [Composition for Film Formation]

The composition for film formation according to the present invention contains the aromatic ester compound and the compound having a cage structure as described above.

The composition for film formation of the present invention may also contain additives such as radical generator, colloidal silica, surfactant, silane coupling agent, and an adhesion promoter at an amount that does not adversely affect various properties (heat resistance, dielectric constant, mechanical strength, coatability, adhesion properties, and the like) of the insulating film formed by the composition for film formation.

A radical generator is a compound which generates a radical of an atom such as carbon, oxygen, or nitrogen when exposed to thermal or light energy, and which has the function of promoting the film curing.

The composition of the present invention may also contain a colloidal silica. The colloidal silica is not particularly limited as long as it does not adversely affect the object of the present invention. Typically, the colloidal silica is a dispersion of a highly pure anhydrous silicic acid in a hydrophilic organic solvent or water typically having an average particle size of 5 to 30 nm and preferably 10 to 20 nm and a solid content of 5 to 40% by weight.

The composition of the present invention may also contain a surfactant. The surfactant is not particularly limited as long as it does not adversely affect the object of the present invention. Exemplary surfactants include nonionic surfactants, anionic surfactants, and cationic surfactants as well as silicone surfactants, fluorine containing surfactants, polyalkylene oxide surfactants, and acrylic surfactants. These surfactants may be used alone or in combination of two or more. Among these, the preferred are silicone surfactants, nonionic surfactants, fluorine containing surfactants, and acrylic surfactants, and the most preferred is use of a silicone surfactant.

The surfactant is preferably used in the present invention at an amount of 0.01 to 1% by weight, and more preferably at 0.1 to 0.5% by weight in relation to the entire amount of the coating composition for the film formation.

The term “silicone surfactant” as used herein means a surfactant containing at least one Si atom. Although the silicone surfactant used in the present invention is not particularly limited, use of a surfactant having a structure containing an alkylene oxide and dimethylsiloxane is preferable. More specifically, the surfactant may contain the following structure containing the moiety represented by the following chemical formula:

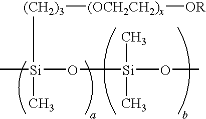

wherein R independently represents hydrogen atom or an alkyl group containing 1 to 5 carbon atoms, x represents an integer of 1 to 20, and a and b independently represent an integer of 2 to 100. In cases where a plurality of R moieties are present, these may be the same or different.

Examples of the silicone surfactant which may be used in the present invention include BYK306 and BYK307 (manufactured by BIG Chemie Company), SH7PA, SH21PA, SH28PA, and SH30PA (manufactured by Toray-Dow Corning-Silicone Company), and Troysol S366 (manufactured by Troy Chemical Company).

The nonionic surfactant used in the present invention is not particularly limited as long as it does not adversely affect the object of the present invention. Exemplary nonionic surfactants include polyoxyethylene alkyl ethers, polyoxyethylene aryl ethers, polyoxyethylene dialkyl esters, sorbitan fatty acid esters, fatty acid-modified polyoxyethylenes, and polyoxyethylene-polyoxypropylene block copolymers.

The fluorine containing surfactant used in the present invention may be any fluorine containing surfactant as long as it has no adverse effects on the merits of the invention. Examples include perfluorooctylpolyethylene oxide, perfluorodecylpolyethylene oxide, and perfluorododecylpolyethylene oxide.

The acryl surfactant used in the present invention may be any acrylic surfactant as long it has no adverse effects on the merits of the invention. Examples include (meth)acrylic acid copolymers.

The silane coupling agent used in the present invention may be any silane coupling agent as long it has no adverse effects on the merits of the invention. Examples include 3-glycidyloxypropyltrimethoxysilane, 3-aminoglycidyloxy-propyltriethoxysilane, 3-methacryloxypropyltrimethoxysilane, 3-glycidyloxypropylmethyldimethoxysilane, 1-methacryloxypropyl-methyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxy-silane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyl-triethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyl-triethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane, which may be used alone or in combination of two or more.

The adhesion promoter used in the present invention may be any adhesion promoter as long it has no adverse effects on the merits of the invention. Examples include trimethoxysilylbenzoic acid, γ-methacryloxypropyltrimethoxysilane, vinyltriacetoxysilane, vinyltrimethoxysilane, γ-isocyanatepropyltriethoxysilane, γ-glycidoxypropyltrimethoxy-silane, β-(3,4-epoxycyclohexyl)ethyltrimethoxysilane, trimethoxyvinylsilane, γ-aminopropyltriethoxysilane, aluminummonoethylacetoacetatediisopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-chloropropylmethyldimethoxy-silane, 3-chloropropyltrimethoxysilane, 3-methacryloxypropyl-trimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, dimethyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazol, 2-mercaptobenzoxazole, urazole, thiouracil, mercaptoimidazole, mercaptopyrimidine, 1,1-dimethyl urea, 1,3-dimethyl urea, and thiourea compound. Use of a functional silane coupling agent for the adhesion promoter is preferable. The adhesion promoter is preferably used at an amount of up to 10 parts by weight, and in particular, at 0.05 to 5 parts by weight in relation to 100 parts by weight of the total solid content.

The composition for film formation of the present invention may have a pore formation factor incorporated therein at a content that does not adversely affect the mechanical strength of the film to thereby produce porous film having low dielectric constant.

The pore forming factor added as a pore forming agent is not particularly limited. However, the preferred is use of a non-metallic compound, and the pore forming agent should simultaneously have the solubility in the solvent used in preparing the coating solution for film formation and the compatibility with the polymer. The pore forming agent should also have a boiling point or decomposition temperature preferably in the range of 100 to 500° C., more preferably 200 to 450° C., and most preferably 250 to 400° C. The molecular weight is preferably 200 to 50,000, more preferably 300 to 10000, and most preferably 400 to 5000. The amount added is preferably 0.5 to 75% by weight, more preferably 0.5 to 30% by weight, and most preferably 1 to 20% by weight in relation to the polymer which forms the film. Alternatively, the pore forming factor may be the decomposable group in the polymer, which decomposes at a decomposition temperature of preferably 100 to 500° C., more preferably 200 to 450° C., and most preferably 250 to 400° C. The content of the decomposable group may be 0.5 to 75 mole %, more preferably 0.5 to 30 mole %, and most preferably 1 to 20 mole % in relation to the polymer which forms the film.

The composition for film formation of the present invention may preferably have a sufficiently low metal impurity content. The metal concentration of the composition for film formation can be measured at a high sensitivity by ICP-MS method, and in such case, the content of metals other than the transition metal is preferably up to 30 ppm, more preferably up to 3 ppm, and most preferably up to 300 ppb. The transition metal has a high catalytic activity for promoting the oxidation, and the transition metal will increase the dielectric constant of the film prepared by the present invention due to the oxidation in the prebake and the thermal cure processes. Accordingly, the composition may preferably have a lowest possible content of the transition metal and the content is preferably up to 10 ppm, more preferably up to 1 ppm, and most preferably up to 100 ppb.

The metal concentration in the composition for film formation can be evaluated by conducting total reflection X-ray fluorescence analysis for the film obtained by using the composition for film formation of the present invention. When W ray is used as an X-ray source, metal elements such as K, Ca, Ti, Cr, Mn, Fe, Co, Ni, Cu, Zn and Pd can be detected, and the content of each metal element is preferably up to 100×10¹⁰ cm⁻², more preferably up to 50×10¹⁰ cm⁻², and most preferably up to 10×10¹⁰ cm⁻². In addition, this method also permits detection of a halogen atom Br and the residual amount is preferably up to 10,000×10¹⁰ cm⁻², more preferably up to 1,000×10¹⁰ cm⁻², and most preferably up to 400×10¹⁰ cm⁻². This method also permits the detection of Cl as another halogen atom, while the residual content is preferably up to 100×10¹⁰ cm⁻², more preferably up to 50×10¹⁰ cm⁻², and most preferably up to 10×10¹⁰ cm⁻², in view of preventing the damages on the CVD apparatus, etching device, and the like.

The solvent used in producing the coating solution is not particularly limited, and the examples include alcohol solvents such as methanol, ethanol, 2-propanol, 1-butanol, 2-ethoxymethanol, 3-methoxypropanol, and 1-methoxy-2-propanol; ketone solvents such as acetone, acetyl acetone, methyl ethyl ketone, methyl isobutyl ketone, 2-pentanone, 3-pentanone, 2-heptanone, 3-heptanone, cyclopentanone, and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate, and γ-butyrolactone; ether solvents such as diisopropyl ether, dibutyl ether, ethyl propyl ether, anisole, phenetole, and veratrole; aromatic hydrocarbon solvents such as mesitylene, ethylbenzene, diethylbenzene, propylbenzene, and t-butylbenzene; and amide solvents such as N-methylpyrrolidone and dimethyl acetamide, which may be used alone or in combination of two or more.

Of these solvents, the preferred is use of 1-methoxy-2-propanol, propanol, acetyl acetone, cyclohexanone, propylene glycol monomethyl ether acetate, butyl acetate, methyl lactate, ethyl lactate, γ-butyrolactone, anisole, mesitylene, or t-butylbenzene, and the most preferred is use of 1-methoxy-2-propanol, cyclohexanone, propylene glycol monomethyl ether acetate, ethyl lactate, γ-butyrolactone, t-butylbenzene, or anisole.

When such solvent is used for preparing the coating solution, the composition for the film formation of the present invention may preferably have a solid content of 1 to 50% by weight, and more preferably, 2 to 15% by weight, and most preferably, 3 to 10% by weight.

The method used for producing the composition for film formation as described above is not particularly limited. For example, an aromatic ester compound represented by the general formula (I), a compound having a cage structure, an organic solvent, and other optional components may be charged in an agitator such as a blender to fully stir the mixture.

### [Film Production Method]

The film produced by using the composition for film formation of the present invention can be formed by coating the composition for film formation on a substrate by any method such as spin coating, roller coating, dip coating, or scan coating, and thereafter removing the solvent by a heat treatment. The coating on a substrate is preferably carried out by spin coating or scan coating, and most preferably by spin coating using a commercially available apparatus such as Clean Truck Series (manufactured by Tokyo Electron Co., Ltd.), D-Spin Series (manufactured by Dai-Nippon Screen Co., Ltd.), or SS Series or CS Series (manufactured by Tokyo Ohka Kogyo Co., Ltd.). The spin coating may be conducted at any rotation speed. However, the preferred is the spin coating at the rotation speed of about 1300 rpm in the case of a silicon substrate of 300 mm in view of in-plane consistency. In the spin coating, the solution of the composition may be dispensed either by dynamic dispensation onto the rotating substrate or by static dispensation on the static substrate, the dynamic dispensation being the preferred in view of the in-plane consistency of the resulting film. Alternatively, the main solvent of the composition may be preliminarily dispensed on the substrate to form a liquid film, and the solution may then be dispensed onto the liquid film in order to suppress the amount of the composition consumed. While the time used for the spin coating is not particularly limited, the spin coating is preferably accomplished within the period of 180 seconds in view of the throughput. The spin coated substrate may be further treated by edge rinsing or back rinsing to leave no film on the edge portion of the substrate for facilitating the transportation. The method used for the heat treatment is not particularly limited. The heat treatment, however, may be conducted by heating on a hot plate, heating in a furnace, heating by light beam irradiation using a xenon lamp, for example, by RTP (Rapid Thermal Processor) which are commonly used in the art, and the preferred is the heating on a hot plate or in a furnace. Preferable hot plates which may be used include Clean Truck Series (manufactured by Tokyo Electron Co., Ltd.), D-Spin Series (manufactured by Dai-Nippon Screen Co., Ltd.), and SS Series or CS Series (manufactured by Tokyo Ohka Kogyo Co., Ltd.). Examples of the preferable furnace include α-Series (manufactured by Tokyo Electron Co., Ltd.).

The substrate used is not particularly limited, and exemplary substrates include silicon wafer, SiO₂ wafer, SiN wafer, glass substrate, ceramic substrate, and plastic substrate from which an adequate substrate may be selected depending on the intended use. The preferred is the use of a substrate having metal interconnects such as a semiconductor integrated circuit having copper-containing interconnects.

The composition of the present invention coated on the substrate is most preferably cured by a heat treatment, for example, by using polymerization of carbon-carbon triple bond remaining in the composition by post heat treatment conducted under the conditions of preferably 100 to 450° C., more preferably 200 to 420° C., and most preferably 350° C. to 400° C. preferably for 1 minute to 2 hours, more preferably 10 minutes to 1.5 hours, and most preferably 30 minutes to 1 hours. This post heat treatment may also be conducted in several separate stages, and the post heat treatment is preferably conducted in nitrogen atmosphere to prevent thermal oxidation by oxygen.

In the present invention, the coated film may be cured by polymerizing the carbon-carbon triple bond remaining in the composition by irradiating the film with a high energy beam instead of conducting the heat treatment. Examples of the high energy beam which may be used include electron beam, UV beam, and X-ray beams. The film may also be cured by other methods.

When the high energy beam used is the electron beam. The energy of the electron beam is preferably 0 to 50 keV, more preferably 0 to 30 keV, and most preferably 0 to 20 keV. The total dose of the electron beam is preferably 0 to 5 μC/cm², more preferably 0 to 2° C./cm², and most preferably 0 to 1 μC/cm². The temperature of the substrate during the irradiation is preferably 0 to 450° C., more preferably 0 to 400° C., and most preferably 0 to 350° C. The pressure during the irradiation is preferably 0 to 133 kPa, more preferably 0 to 60 kPa, and most preferably 0 to 20 kPa. The substrate is preferably irradiated in an inert gas atmosphere of Ar, He, nitrogen, or the like for the purpose of preventing the oxidation of the polymer of the present invention. A gas such as oxygen, hydrocarbon, or ammonia may also be added for the interaction with the plasma, electromagnetic wave, or chemical species generated by the interaction with electron beam. The electron beam-irradiation may be carried out in a plurality of stages, and in this case, the conditions used for the electron beam do not have to be necessarily the same and different conditions may be used from stage to stage.

The high energy beam used may be UV beam. When UV beam is used, the UV beam used may preferably have a wavelength in the range of 190 to 400 nm, and the output is preferably in the range of 0.1 to 2000 mW/cm² when measured just above the substrate. The temperature of the substrate during the UV irradiation is preferably in the range of 250 to 450° C., more preferably 250 to 400° C., and most preferably 250 to 350° C. The substrate is preferably irradiated in an inert gas atmosphere of Ar, He, nitrogen, or the like for the purpose of preventing the oxidation of the polymer of the present invention. The pressure during the irradiation is preferably 0 to 133 kPa.

When the film obtained by using the composition for film formation of the present invention is used as an interlayer insulating film for a semiconductor, the interconnect structure may have a barrier layer for preventing metal migration on the side surface of the interconnect, and a cap layer, an interlayer adhesion layer, an etch stopper layer, and the like for preventing peeling in the CMP. If desired, the interlayer insulating film may comprise two or more layer each comprising different materials.

The film obtained by using the composition for film formation of the present invention may be etched for the formation of copper interconnects and other purposes. The etching may be carried out either by wet etching or dry etching, and the preferred is dry etching. The dry etching may be conducted by using any one of ammonia plasma and fluorocarbon plasma. Not only Ar, but also, gases such as oxygen, nitrogen, hydrogen, or helium may be used for the plasma. The substrate may also be subjected to ashing for removing the photoresist after the completion of the etching, and further, the substrate can be washed to remove any residue remaining after the ashing.

The film obtained by using the composition for film formation of the present invention may be subjected to CMP (chemical mechanical polishing) for planarization of copper-plated area after the formation of the copper interconnects. The CMP slurry (reagent) may be adequately selected from commercially available slurries (for example, those manufactured by FUJIMI Company, Rhodel-Nitta Company, JSR Company, Hitachi Chemical Co., Ltd., and the like). The CMP apparatus may be selected from commercially available systems (for example, those manufactured by Applied Material Company, Ebara Corporation, and the like). After the CMP, remaining slurry may be removed by washing.

The film obtained by using the composition for film formation of the present invention can be used in a variety of applications including various electronic devices. More specifically, the film obtained is well adapted for use as an insulating film in a semiconductor device such as LSI, system LSI, DRAM, SDRAM, RDRAM, and D-RDRAM, or electronic parts such as multi-chip module multi-layer circuit board as well as an interlayer insulating film of a semiconductor, etching stopper film, surface protection film, buffer coating film, passivation film of LSI, α-beam-shielding film, cover lay film of a flexographic plate, overcoat film, cover coating of a flexible copper clad laminate, solder resist film, liquid crystal alignment film, and the like.

The film of the present invention may be doped with an electron donor or acceptor to impart electrodconductivity with the film to thereby use the film as an electroconductive film.

The film obtained by using the composition for film formation of the present invention exhibits improved dielectric properties as well as long term stability of relative dielectric constant. Although detailed mechanism of the present invention is unknown, formation of pores which are likely to cause adsorption of moisture and the like may be suppressed by the use of the compound having a cage structure and the aromatic ester compound. In other words, pores in the film is believed to be controlled. More specifically, the compound having the cage structures (a) and (b) has good compatibility with the aromatic ester compound, and this compatibility is postulated to be the cause of the remarkable effects.

The film obtained by using the composition for film formation according to the present invention exhibits excellent resistance to cracking. Particularly the compound having the cage structure (b) and more particularly the cage silsesquioxane have excellent resistance to cracking.

### EXAMPLES

Next, the present invention is described in further detail by referring to the Examples, which by no means limit the scope of the present invention.

The measurement by GPC was carried out using Waters 2695 and GPC column KF-805L manufactured by Shodex at a column temperature of 40° C. and using tetrahydrofuran for the elution solvent at a flow rate of 1 ml/min. The Mw, Mn and M_{z+1} were calculated by using a calibration curve depicted by using a standard polystyrene.

### Synthetic Example 1

4,9-diethynyl diamantane (a) was synthesized according to the method described in Macromolecules, 5266 (1991). Next, 2-g of 4,9-diethynyldiamantane (a), 0.22 g of dicumyl peroxide (PERCUMYL D manufactured by NOF Corporation), and 10 ml of diphenyl ether were mixed and stirred under nitrogen stream at an internal temperature of 150° C. for 7 hours for polymerization. The reaction mixture was cooled to room temperature, and added to 60 ml of isopropyl alcohol. The solid precipitate was separated by filtration, and fully washed with isopropyl alcohol to obtain the desired polymer of the 4,9-diethynyldiamantane (a).

The procedure as described above was repeated except that the dicumyl peroxide (PERCUMYL D manufactured by NOF Corporation) was used at different amounts to produce other polymers of 4,9-diethynyldiamantane (a) respectively having a different molecular weight.

### Synthetic Example 2

The procedure of Synthetic Example 1 was repeated except that 3,3,3′,3′-triethynyl-1,1′-biadamantane (b) was used instead of the 4,9-diethynyldiamantane (a) which is the monomer used in the Synthetic Example 1 to produce a polymer of 3,3,3′,3′-triethynyl-1,1′-biadamantane (b).

### Synthetic Example 3

The procedure of Synthetic Example 1 was repeated except that 3,3′-diethynyl-1,1′-biadamantane (c) was used instead of the 4,9-diethynyldiamantane (a) which is the monomer used in the Synthetic Example 1 to produce a polymer of 3,3′-diethynyl-1,1′-biadamantane (c).

### Synthetic Example 4

The procedure of Synthetic Example 1 was repeated except that 1,6-diethynyldiamantane (d) was used instead of the 4,9-diethynyldiamantane (a) which is the monomer used in the Synthetic Example 1 to produce a polymer of 1,6-diethynyldiamantane (d).

### Synthetic Example 5

The procedure of Synthetic Example 1 was repeated except that the compound (I-a) as mentioned above was used instead of the 4,9-diethynyldiamantane (a) which is the monomer used in the Synthetic Example 1 to produce a polymer of the compound (I-a).

### Synthetic Example 6

The procedure of Synthetic Example 1 was repeated except that the compound (I-d) as mentioned above was used instead of the 4,9-diethynyldiamantane (a) which is the monomer used in the Synthetic Example 1 to produce a polymer of the compound (I-d).

### Examples 1 to 26 and Comparative Example 1

### Preparation of the Composition for Film Formation

1 g of one polymer produced in the Synthetic Examples and the aromatic ester compound shown in Table 1 were fully dissolved in a solvent (g) to prepare the coating solution of the composition for film formation. In Table 1, the amount of the aromatic ester compound added (wt %) is the amount of the aromatic ester compound in % by weight in relation to the total solid content (the polymer and the aromatic ester compound) in the coating solution.

The polymer of the 4,9-diethynyl diamantane (a) as described above was used in Comparative Example 1.

### [Measurement of Dielectric Constant of the Film]

The coating solution prepared as described above was coated on an 8-inch bare silicon wafer having a substrate resistance of 7 Ω/cm by using a spin coater ACT-8 SOD manufactured by Tokyo Electron Ltd. The resulting film was baked at 110° C. for 60 seconds, and then, at 200° C. for 60 seconds, and further baked in a clean oven at 400° C. that had been purged with nitrogen for 1 hour to produce a coating film having a thickness of 100 nm. Relative dielectric constant of the resulting film was calculated from the capacitance value at 1 MHz by using a mercury probe manufactured by Four Dimensions and HP4285A LCR meter manufactured by Yokogawa Hewlett-Packard. The dielectric constant immediately after the baking in the clean oven is designated dielectric constant (1).

[Evaluation for Stability of the Dielectric Constant after the Film Formation]

The insulating films prepared by using each coating solution were exposed to an environment at a temperature of 110° C. and a relative humidity of 90% for 12 hours using Highly Accelerated Stress Test Systems EHS-221(M) manufactured by ESPEC CORP. The dielectric constant of the film after the test was designated dielectric constant (2), and the difference between the dielectric constant (1) and the dielectric constant (2) was used for the index of the stability of the dielectric constant. The dielectric constant under the high temperature, high humidity conditions can be regarded stable when this difference (dielectric constant (2)-dielectric constant (1)) is near 0. The results are summarized in Table 1.

TABLE 1

| | | Weight average | | | | Dielectric |
|---|---|---|---|---|---|---|
| | | molecular weight | Amount of the | | | constant (2) − |
| | | of the compound | aromatic ester | | Dielectric | Dielectric |
| | Starting monomer for the | having cage | compound added | | constant | constant |
| | compound having cage structure | structure | (wt %) | Solvent | (1) | (1) |
| Example | | | | | | |
| 1 2 3 4 5 6 7 8 9 | 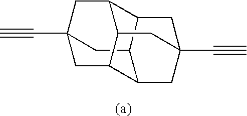 | 21200 35000 76000 | (II-a) 10.0 wt % (II-c) 10.0 wt % (II-d) 5.0 wt % (II-b) 10.0 wt % (II-d) 15.0 wt % (II-e) 10.0 wt % (II-b) 5.0 wt % (II-b) 10.0 wt % (II-c) 10.0 wt % | (α) (α) (γ) (α) (α) (α) (α) (α) (α) | 2.42 2.45 2.46 2.44 2.43 2.41 2.45 2.47 2.44 | 0.02 0.01 0.03 0.02 0.01 0.03 0.03 0.02 0.01 |
| 10 11 12 | 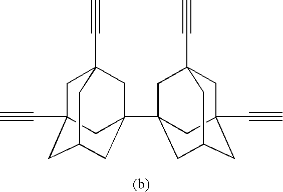 | 26200 | (II-a) 15.0 wt % (II-b) 10.0 wt % (II-d) 10.0 wt % | (α) (γ) (α) | 2.58 2.55 2.53 | 0.04 0.03 0.01 |
| 13 14 15 | 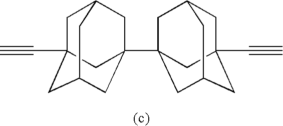 | 12300 | (II-c) 5.0 wt % (II-d) 5.0 wt % (II-c) 10.0 wt % | (α) (α) (α) | 2.52 2.49 2.47 | 0.02 0.05 0.01 |
| 16 17 18 | 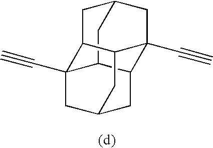 | 15600 | (II-d) 15.0 wt % (II-d) 10.0 wt % (II-a) 10.0 wt % | (α) (α) (α) | 2.48 2.42 2.45 | 0.04 0.02 0.05 |
| 19 20 21 22 | 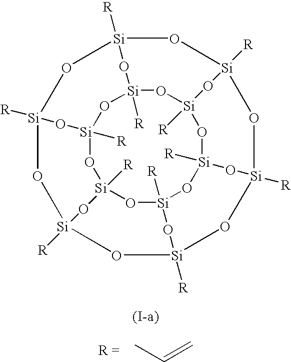 | 89600 | (II-a) 5.0 wt % (II-b) 10.0 wt % (II-d) 10.0 wt % (II-e) 10.0 wt % | (β) (β) (β) (γ) | 2.26 2.21 2.22 2.26 | 0.05 0.01 0.02 0.03 |
| 23 24 25 26 | 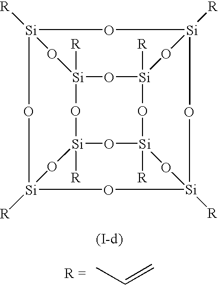 | 96870 | (II-c) 5.0 wt % (II-c) 10.0 wt % (II-b) 5.0 wt % (II-d) 10.0 wt % | (β) (β) (β) (β) | 2.21 2.24 2.25 2.22 | 0.03 0.01 0.05 0.02 |
| Comparative | | | | | | |
| Example | | | | | | |
| 1 | 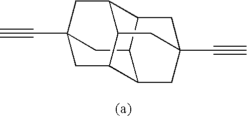 | 21200 | — | (α) | 2.45 | 0.21 |

[Aromatic ester compound]
(II-a) di-2-ethylhexyl phthalate manufactured by Kanto Chemical Co., Inc.
(II-b) diisononyl phthalate manufactured by Wako Pure Chemical Industries
(II-c) diisodecyl phthalate manufactured by Wako Pure Chemical Industries
(II-d) tris(2-ethylhexyl) trimellitate manufactured by ALDRICH
(II-e) UL80 (octyl pyromellitate ester) manufactured by ADEKA
[Solvent]
(α) cyclohexanone
(β) propylene glycol monomethyl ether acetate
(γ) 2-heptanone

As demonstrated in Table 1, the composition for film formation of the present invention had more stable dielectric constant with reduced increase in the dielectric constant even under the high temperature, high humidity conditions.

### [Measurement of Resistance to Cracking]

The coating solution prepared as described above was coated on an 8-inch bare silicon wafer having a substrate resistance of 7 Ω/cm by using a spin coater ACT-8 SOD manufactured by Tokyo Electron Ltd. The resulting film was baked at 110° C. for 60 seconds, and then, at 200° C. for 60 seconds, and further baked in a clean oven at 400° C. that had been purged with nitrogen for 1 hour to produce a coating film having a thickness of 1.5 um (μm). Cracks of the resulting film were observed with an optical microscope (Semiconductor Inspection Microscope MX50 manufactured by Olympus Corporation) or Hitachi Ultrahigh-Resolution Field Emission Scanning Electron Microscope S-4800 manufactured by Hitachi High-Technologies Corporation. The film was rated as “good” when there were no cracks and as “poor” when there were cracks. The results are shown in Table 2.

TABLE 2

| | | Weight average | | | |
|---|---|---|---|---|---|
| | | molecular weight | Amount of the | | |
| | | of the compound | aromatic ester | | Cracking |
| | Starting monomer for the | having cage | compound added | | resistance |
| | compound having cage structure | structure | (wt %) | Solvent | (1.5 μm) |
| Example | | | | | |
| 27 28 29 30 31 32 33 34 35 | 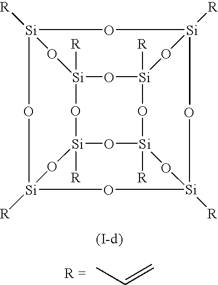 | 50000 96870 17000 | (II-a) 10.0 wt % (II-c) 15.0 wt % (II-d) 20.0 wt % (II-b) 15.0 wt % (II-d) 25.0 wt % (II-e) 10.0 wt % (II-b) 15.0 wt % (II-c) 10.0 wt % (II-d) 30.0 wt % | (α) (α) (β) (α) (β) (α) (α) (β) (β) | Good Good Good Good Good Good Good Good Good |
| 36 37 38 | 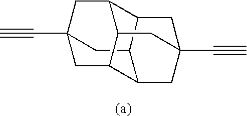 | 21200 | (II-a) 15.0 wt % (II-b) 10.0 wt % (II-d) 20.0 wt % | (α) (γ) (α) | Good Good Good |
| 39 40 41 | 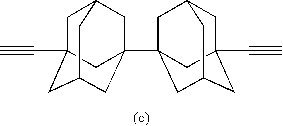 | 12300 | (II-c) 15.0 wt % (II-d) 20.0 wt % (II-c) 10.0 wt % | (α) (α) (α) | Good Good Good |
| 42 43 44 45 | 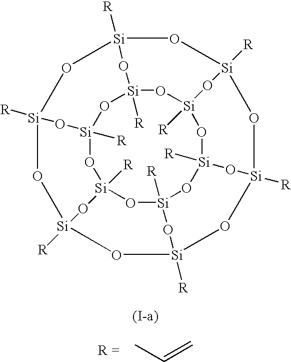 | 89600 | (II-a) 15.0 wt % (II-b) 30.0 wt % (II-d) 20.0 wt % (II-e) 10.0 wt % | (β) (β) (β) (γ) | Good Good Good Good |
| Comparative | | | | | |
| Example | | | | | |
| 2 | 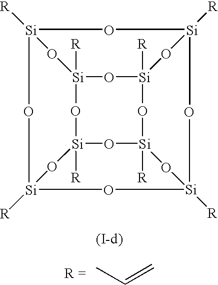 | 96870 | — | (α) | Poor |

[Aromatic ester compound]
(II-a) di-2-ethylhexyl phthalate manufactured by Kanto Chemical Co., Inc.
(II-b) diisononyl phthalate manufactured by Wako Pure Chemical Industries
(II-c) diisodecyl phthalate manufactured by Wako Pure Chemical Industries
(II-d) tris(2-ethylhexyl) trimellitate manufactured by ALDRICH
(II-e) UL80 (octyl pyromellitate ester) manufactured by ADEKA
[Solvent]
(α) cyclohexanone
(β) propylene glycol monomethyl ether acetate
(γ) 2-heptanone

As demonstrated in Table 2, it was confirmed that the film obtained by using the composition for film formation of the present invention had excellent resistance to cracking.

On the other hand, cracks were confirmed to occur in Comparative Example 2 in which the composition contained no aromatic ester compound.

What is claimed is:

1. A composition for forming a film comprising a compound having a cage structure and an aromatic ester compound represented by the following general formula (1): 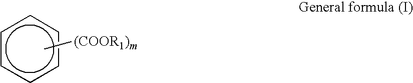
wherein R₁ represents an alkyl group, and m represents an integer of 1 to 6 with the proviso that R₁ may be either the same or different when m represents an integer of 2 or more.

2. The composition for film formation according to claim 1 wherein m in the general formula (1) is an integer of 2 to 6.

3. The composition for film formation according to claim 1 wherein the aromatic ester compound is one represented by the following general formula (II): 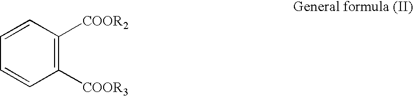
wherein R₂ and R₃ independently represent an alkyl group.

4. The composition for film formation according to claim 1 wherein the aromatic ester compound is one represented by the following general formula (III): 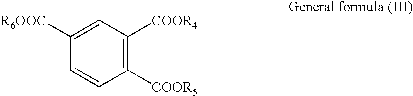
wherein R₄ to R₆ independently represent an alkyl group.

5. The composition for film formation according to claim 1 wherein the aromatic ester compound is one represented by the following general formula (IV): 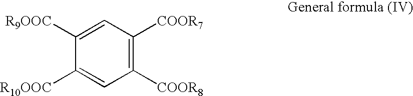
wherein R₇ to R₁₀ independently represent an alkyl group.

6. The composition for film formation according to claim 1 wherein the alkyl group is a long chain alkyl group containing at least 6 carbon atoms.

7. The composition for film formation according to claim 1 wherein the compound having a cage structure is a polymer of a monomer having a cage structure.

8. The composition for film formation according to claim 7 wherein the monomer having a cage structure has a polymerizable carbon-carbon double bond or carbon-carbon triple bond.

9. The composition for film formation according to claim 1 wherein the cage structure is a member selected from the group consisting of adamantane, biadamantane, diamantane, triamantane, and tetramantane.

10. The composition for film formation according to claim 7 wherein the monomer having a cage structure is a compound represented by any one of the following general formulae (V) to (X): 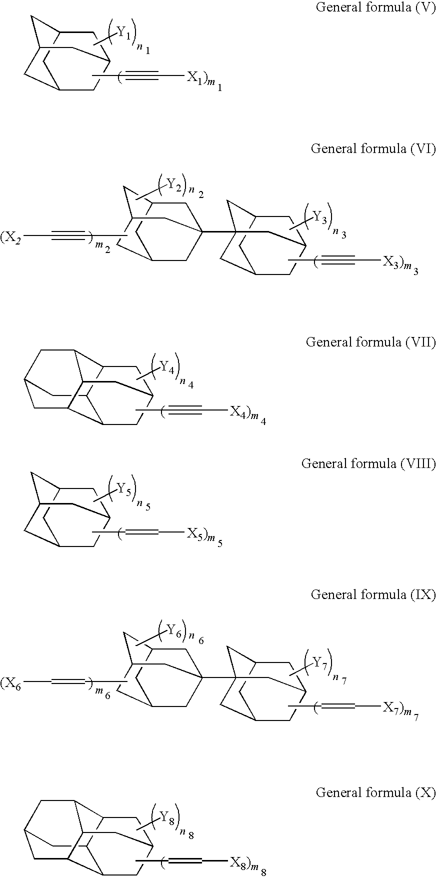
wherein X₁ to X₈ independently represent hydrogen atom, an alkyl group containing 1 to 10 carbon atoms, an alkenyl group containing 2 to 10 carbon atoms, an alkynyl group containing 2 to 10 carbon atoms, an aryl group containing 6 to 20 carbon atoms, a silyl group containing 0 to 20 carbon atoms, an acyl group containing 2 to 10 carbon atoms, an alkoxycarbonyl group containing 2 to 10 carbon atoms, or a carbamoyl group containing 1 to 20 carbon atoms,
Y₁ to Y₈ independently represent a halogen atom, an alkyl group containing 1 to 10 carbon atoms, an aryl group containing 6 to 20 carbon atoms, or a silyl group containing 0 to 20 carbon atoms,
m₁ and m₅ independently represent an integer of 1 to 16, and n₁ and n₅ independently represent an integer of 0 to 15,
m₂, m₃, m₆, and m₇ independently represent an integer of 1 to 15, and n₂, n₃, n₆, and n₇ independently represent an integer of 0 to 14, and
m₄ and m₈ independently represent an integer of 1 to 20, and n₄ and n₈ independently represent an integer of 0 to 19.

11. The composition for film formation according to claim 7 wherein the monomer having a cage structure is a compound represented by any one of the following general formulae (Q-1) to (Q-6): 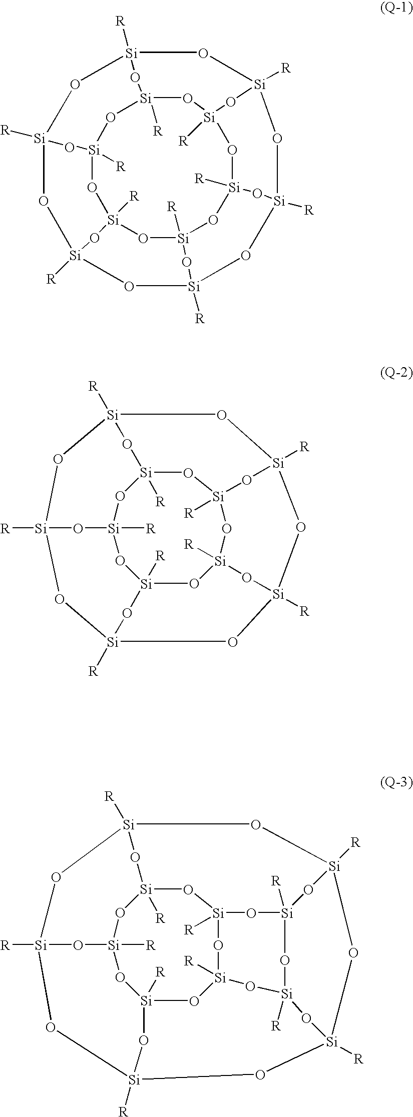 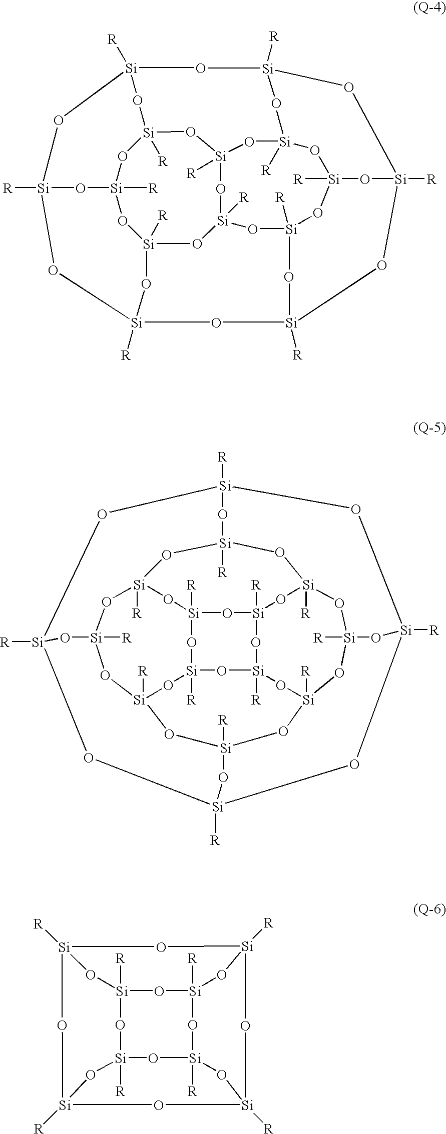
wherein R independently represents a non-hydrolyzable group, and at least 2 of the R are groups containing either vinyl group or ethynyl group.

12. An insulating film formed by using the composition for film formation of any one of claims 1 to 11.

13. An electronic device having the insulating film of claim 12.
